(19) United States
(12) Patent Application Publication
(10) Pub. No.: US 2026/0161211 A1
(43) Pub. Date: Jun. 11, 2026

(54) System and method for optimizing power consumption in a data center

(71) Applicant: Bank of America Corporation, Charlotte, NC (US)

(72) Inventors: Aarron Gull, East Northport, NY (US); Steven W Lester, Prosper, TX (US)

(21) Appl. No.: 18/971,702

(22) Filed: Dec. 6, 2024

(51) Int. Cl. G06F 1/3228; G06F 11/30

(52) U.S. Cl. CPC G06F 1/3228; G06F 11/3058

(57) ABSTRACT

An AI model is trained to optimize power consumption associated with cooling processing servers of a data center by determining migration of one or more software applications or portions thereof among the processing servers to distribute heat among the processing servers. Upon executing a machine-learning model, the AI model predicts that a scheduled processing of a software application by a first processing server can cause the temperature of the first processing server to equal or exceed a threshold temperature. In response, the AI model generates a recommendation to migrate the processing of the software application from the first processing server to a second processing server. Based on the recommendation, the software application is migrated from the first processing server to the second processing server.

### TECHNICAL FIELD

The present disclosure relates generally to data centers, and more specifically to a system and method for optimizing power consumption in a data center.

### BACKGROUND

A data center is a physical facility used by organizations to house their Information Technology (IT) operations and equipment, such as servers, storage systems, networking hardware, and other critical infrastructure. Several inefficiencies are associated with conventional data centers in relation to detecting and resolving performance anomalies occurring in a data center. Additional inefficiencies exist in relation to optimizing power consumption in a data center.

### SUMMARY

The system and method implemented by the system as disclosed in the present disclosure provide technical solutions to the technical problems discussed above by providing an improved data center that overcomes the inefficiencies of conventional data centers.

### Predicting and Resolving Performance Anomalies in a Data Center

Several performance anomalies can occur in a data center that can adversely affect performance of the data center. A “performance anomaly” in a data center generally refers to a significant deviation from the expected, normal operating behavior of a data center equipment such as a processing server, network equipment, or other system within the data center, often manifesting as a sudden spike or drop in performance metrics like CPU response, CPU usage, memory utilization, network throughput, disk I/O, or application response times indicating a potential issue that needs investigation and troubleshooting. Performance anomalies in a data center can lead to a range of problems including reduced system performance (e.g., reduced processing performance of processing servers), application slowdowns, data loss, increased latency, service disruptions, system downtime, reputational damage, and compromised security. Accordingly, it is critical that performance anomalies associated with a data center are avoided to prevent these problems from occurring.

In conventional data centers, detecting and resolving performance anomalies in can be a challenging task due to a number of technical, operational, and environmental limitations. These limitations can arise from both the complexity of the data center's infrastructure and the nature of the anomaly itself. For example, modern data centers generate vast amounts of performance data (e.g., network traffic, storage usage, CPU/memory utilization, power consumption). Monitoring all of these data streams can overwhelm the monitoring systems and make it difficult to identify true performance issues amidst the noise. For example, performance anomaly detection systems (e.g., performance monitoring tools) often produce false positives due to misconfigurations, transient events, or noisy data. When too many alerts are generated, teams may become desensitized to the warnings, making it difficult to distinguish real issues from routine fluctuations. Further, the data center infrastructure includes complex dependencies often consisting of numerous interdependent systems (e.g., compute, storage, networking). Anomalies in one part of the system may propagate to other components, making it hard to pinpoint the root cause. Some monitoring tools lack the granularity necessary to detect anomalies at the level of individual components or workloads. For example, aggregate data might obscure performance problems that only affect a specific server, application, or user. In some cases, monitoring systems may not have full visibility into all layers of the infrastructure (e.g., network devices, virtualized environments, or third-party services), leading to incomplete or inaccurate performance assessments.

Many data centers are reactive in nature, only addressing performance anomalies after they have already impacted users or applications. A proactive approach requires advanced monitoring, trend analysis, and predictive capabilities, which can be difficult to implement effectively. This reactive nature of anomaly detection and resolution means that damage to the data center systems has usually occurred before a performance anomaly is detected and resolved. Further, while anomaly detection systems can alert administrators to performance issues, many require manual intervention to diagnose and resolve. Without adequate automation, this increases the time to resolution and the risk of human error. Some performance issues may escalate quickly (e.g., memory leaks, CPU saturation, or storage exhaustion), and conventional systems for resolving anomalies may not respond fast enough to mitigate the impact on systems, users or applications. As data centers grow, scaling the monitoring infrastructure to handle increased data volume can be challenging. Tools that work well in small environments may struggle to scale effectively in large, distributed data centers.

Embodiments of the present disclosure provide technical solutions to the technical problems described above by providing a practical application of providing techniques to proactively predict performance anomalies associated with a data center and automatically implement remediation processes to avoid the predicted performance anomalies from occurring.

For example, as described in embodiments of the present disclosure, a controller obtains information relating to a plurality of real time performance indicators that indicate real time performance of a data center equipment and inputs this information to an AI model. The AI model is trained based on a plurality of anomaly patterns associated with the data center equipment, to predict a performance anomaly associated with the data center equipment. Each anomaly pattern is associated with a particular performance anomaly previously detected in relation to the data center equipment. Further, each anomaly pattern includes a set of historical performance indicators recorded in a pre-selected time period leading up to a respective performance anomaly previously detected in relation to the data center equipment. The controller executes a machine-learning algorithm associated with the AI model to cause the AI model to compare the plurality of real time performance indicators to a respective set of historical performance indicators associated with each of the plurality of anomaly patterns. Based on the comparison, the AI model determines a pattern of one or more real time performance indicators that matches or closely matches with a particular set of historical performance indicators associated with a particular anomaly pattern. The AI model determines a first performance anomaly associated with the particular anomaly pattern and predicts that the first performance anomaly is to occur in relation to the data center equipment. In response to the prediction of the first performance anomaly in relation to the data center equipment, the controller implements one or more remediation processes to avoid the first performance anomaly from occurring in relation to the data center equipment.

Thus, unlike conventional data centers, the disclosed system and method proactively predict performance anomalies that can occur in the data center and applies remediation processes to avoid or prevent the predicted performance anomalies from occurring. Proactively predicting performance anomalies that can occur in a data center and avoiding or preventing those performance anomalies from occurring provide several technical advantages. For example, performance anomalies such as CPU overutilization, memory leaks, or disk I/O bottlenecks can slow down processing and impact the entire data center. Predicting and addressing these performance anomalies before they occur can avoid performance issues that may otherwise occur when those performance anomalies actually occur. This the disclosed system improves processing performance in the data center by avoiding anomalies such as CPU overutilization, memory leaks, or disk I/O bottlenecks. Another technical advantage resulting from predicting and avoiding performance anomalies includes minimized network congestion. Performance anomalies like network congestion or bandwidth saturation can lead to increased latency, slowing down data transfer speeds and application responsiveness. By predicting and avoiding these anomalies from occurring, network traffic flows more smoothly, ensuring low-latency performance for applications and services hosted in the data center.

### Detecting and Resolving Performance Bottlenecks in a Data Center

Several performance bottlenecks can occur in a data center that can adversely affect performance of the data center. For example, hardware performance anomalies associated with processing servers can cause performance bottlenecks in the processing of software applications by processing servers or processing of software applications by other processing servers that are interdependent. Performance bottlenecks in the processing of a software application operating in a data center can occur due to a wide range of factors that affect various components of the application stack, including hardware, software, network, and resource utilization. Identifying and addressing these bottlenecks is critical to maintaining optimal performance and ensuring that users experience fast, reliable services.

Some examples of hardware performance anomalies that often cause performance bottlenecks associated with processing of software applications in a data center include CPU overload, insufficient memory allocation, slow disk read/write speeds on memory disks, insufficient network bandwidth, and high network latency between components of the data center. Performance bottlenecks in software applications can have a significant impact on overall data center performance. Since data centers host and manage multiple software applications and services, any issues within a software application such as slow response times, resource inefficiency, or service failures can cascade throughout the entire system, leading to degraded performance of the data center and components thereof and increased operational challenges. For example, when a software application experiences performance bottlenecks (e.g., slow response times, inefficient code, database contention, or memory leaks), it consumes more resources than expected such as CPU cycles, memory, and disk I/O. This increased resource consumption can strain the data center's physical infrastructure, leading to overloaded processing servers. Performance bottlenecks in software applications such as slow database queries, inefficient network calls, or excessive CPU utilization can lead to increased latency in data transmission between servers and storage devices resulting in network congestion and slow service response. In addition, inefficient resource usage because of a software bottleneck can cause higher than normal energy/power consumption for the increased CPU usage and memory usage as well as to cool down the higher amount of heat generated by the overactive computing resources.

Detecting and resolving performance bottlenecks in software applications within a conventional data center can be a complex and challenging process. The limitations faced in identifying and addressing these issues stem from a combination of technical, operational, and environmental factors. For example, in conventional data centers, software applications are often distributed across multiple layers of infrastructure, including servers, storage systems, networking components, and virtualization layers. Performance bottlenecks can occur at any layer, and tracking down the root cause requires a comprehensive understanding of the entire system stack, making detection more complex. Software applications based on microservices architectures introduce additional complexity. Bottlenecks in one service can affect multiple other services that depend on it, making it difficult to isolate the problem. Interdependencies between services, databases, APIs, and external systems complicate the detection and resolution process. Conventional data centers do not have end-to-end visibility into application performance, network condition, database queries, and infrastructure metrics in real-time. Without comprehensive monitoring in place, conventional data centers are unable to detect when and where bottlenecks occur.

Embodiments of the present disclosure provide technical solutions to the technical problems described above by providing the practical application of providing techniques for detecting performance bottlenecks occurring in a data center proactively, efficiently and accurately (e.g., in real-time or near real-time) and further automatically implementing remediation processes to alleviate the detected performance bottlenecks.

For example, as described in embodiments of the present disclosure, a controller obtains information relating to a plurality of real time performance indicators that indicate real time performance of a plurality of data center equipment deployed at a data center and software applications running at the plurality of data center equipment. The controller inputs this information to an AI model that is trained based on a plurality of anomaly patterns associated with the data center, to determine that a performance bottleneck has occurred in relation to one of the plurality of data center equipment. Each anomaly pattern is associated with a particular performance bottleneck previously detected in relation to a data center equipment and includes a set of historical performance indicators recorded in relation to the data center equipment and that are associated with the particular performance bottleneck. The controller executes a machine-learning algorithm associated with the AI model to compare one or more real time performance indicators associated with a first data center equipment to a respective set of historical performance indicators associated with each of one or more anomaly patterns. Based on the comparison, the AI model determines a first pattern of at least a portion of the one or more real time performance indicators recorded for the first data center equipment that matches with or closely matches with a first set of historical performance indicators associated with a first anomaly pattern. The AI model then determines a first performance bottleneck associated with the first anomaly pattern and determine that the first performance bottleneck has occurred in relation to the first data center equipment. In response to obtaining the prediction of the first performance bottleneck in relation to the first data center equipment, the controller implement one or more remediation processes to resolve the first performance bottleneck associated with the first data center equipment.

Thus, unlike conventional data centers, the disclosed system and method detect and resolve performance bottlenecks promptly and effectively. Detecting performance bottlenecks occurring in a data center promptly and accurately and further promptly resolving the detected performance bottlenecks provides several technical advantages. Resolving a performance bottleneck in a data center directly improves the performance of the data center in several ways. For example, resolving a performance bottleneck results in improved data center efficiency. By addressing bottlenecks, the system can handle more requests and complete tasks more quickly. This results in faster processing of data, quicker application response times, and overall higher throughput. An additional technical advantage of promptly detecting and resolving performance bottlenecks includes improved resource utilization. For example, when bottlenecks are resolved, the use of data center resources like CPUs, memory, storage, and network bandwidth is maximized. This leads to more efficient operation and prevents certain resources from becoming overworked while others are underutilized. Another technical advantage of promptly detecting and resolving performance bottlenecks includes reduced system latency. Bottlenecks often cause delays in data transfer or processing, leading to slower response times for applications and services. By resolving bottlenecks, latency is reduced, and the performance of critical applications improves, which is especially important for time-sensitive tasks.

### Troubleshooting Performance Anomalies in a Data Center

Finding a resolution to a performance anomaly in a data center can be a complex and challenging task. Performance issues often result from a variety of underlying causes, and identifying the root cause requires a deep understanding of both the infrastructure and workload patterns. A conventional data center faces several technical problems when diagnosing and resolving performance anomalies. A modern data center typically consists of many different components, including servers, storage systems, networking equipment, virtualization layers, and external services. A performance issue in one part of the system may affect others in unpredictable ways, making it difficult to pinpoint the exact source of the anomaly making it difficult to determine an apply a proper resolution. Data centers generate massive amounts of performance and operational data. Logs, metrics, and traces are produced continuously by various systems, and analyzing this data in real-time or retroactively to detect what caused a particular performance anomaly can be overwhelming. Often different instances of a same type of performance anomaly can be caused by different reasons. Thus, a remediation method to be applied to resolve each performance anomaly depends on what caused the anomaly. Conventional data centers are often unable to accurately detect a cause of a performance anomaly. Performance anomalies can be caused by many different factors, including hardware failures, software bugs, configuration issues, network problems, or external factors (e.g., DDoS attacks or third-party service outages). Identifying the root cause requires analyzing data from multiple layers and sources, which can be time-consuming and error prone.

In many cases, diagnosing a performance anomaly involves manually reviewing logs, metrics, and traces, which can be very time-consuming, especially when the issue spans across multiple components. Even with automated monitoring tools, isolating the root cause can still take a considerable amount of time, during which the problem may persist or worsen. Delaying the resolution of a performance anomaly in a data center can have a range of negative consequences, many of which can escalate over time. For example, a performance anomaly that is not addressed promptly can evolve into a system failure, causing longer periods of downtime or service disruptions. Performance issues often have a ripple effect across the data center infrastructure. For instance, a slow network or overloaded storage system can cause delays or failures in other systems, leading to a cascading failure that may involve multiple components and services. Additionally, unresolved performance anomalies, such as slow storage or network performance, can result in higher latency for end-users and customers.

Embodiments of the present disclosure provide technical solutions to the technical problems described above by providing a practical application of providing improved techniques for accurately diagnosing a performance anomaly detected in relation to a data center equipment and determining an appropriate remediation process to resolve performance anomaly.

As described in embodiments of the present disclosure, a controller detects that a first performance anomaly has occurred associated with a first data center equipment deployed at a first data center. In response, the controller obtains a plurality of real time performance indicators recorded in a pre-selected time period before the detection of the first performance anomaly and that indicate real time performance of the first data center equipment in the pre-selected time period. The controller inputs to an AI model information relating to the detected first performance anomaly and the plurality of real time performance indicators associated with the first data center equipment. The AI model is trained, based on a plurality of anomaly patterns associated with a plurality of data center equipment deployed at a plurality of data centers and respective remediation processes associated with the anomaly patterns, to determine one of the remediation processes that can be implemented to resolve the detected first performance anomaly associated with the first data center equipment. Each anomaly pattern is associated with a previously detected performance anomaly at a particular data center equipment deployed at a particular data center of the plurality of data centers. Further, each anomaly pattern comprises a set of performance indicators recorded in the pre-selected time period leading up to a respective performance anomaly previously detected in relation to a particular data center equipment deployed at a particular data center. Each remediation process associated with a respective anomaly pattern was implemented to resolve a respective previously detected performance anomaly associated with the respective anomaly pattern.

The controller executes a machine-learning algorithm associated with the AI model to determine one or more anomaly patterns of the plurality of anomaly patterns that are associated with respective one or more second data center equipment that are same or similar to the first data center equipment and are associated with respective previously detected performance anomalies that are same or similar to the detected first performance anomaly. The AI model compares the plurality of real time performance indicators recorded for the first data center equipment to a respective set of performance indicators associated with the one or more anomaly patterns. Based on the comparison, the AI model determines a pattern of one or more real time performance indicators that matches or closely matches with a particular set of performance indicators associated with a particular anomaly pattern of the one or more anomaly patterns. The AI model identifies a particular remediation process associated with the matching particular anomaly pattern. The controller then implements the particular remediation process in relation to the first data center equipment to resolve the detected first performance anomaly associated with the first data center equipment.

By leveraging anomaly patterns associated with previously detected and resolved performance anomalies, the disclosed system and method avoid the complicated and time-consuming process of analyzing vast amounts of performance and diagnostic data that would otherwise have to be analyzed to determine the exact cause of the performance anomaly. Further, by implementing a remediation process that was implemented to resolve a similar performance anomaly that was previously detected in a data center, the disclosed system and method improve the speed of resolving performance anomalies and avoid delays that can cause system failure, causing longer periods of downtime or service disruptions. Thus, by accurately diagnosing performance anomalies detected in a data center and promptly resolving the detected performance anomalies, the disclosed system and method improve the performance of a data center.

In general, the system and methods disclosed in various embodiments of the present disclosure improve data center technology.

### Optimizing Power Consumption in a Data Center

Generally, processing servers associated with a higher processing performance consume higher electrical power as compared to processing servers associated with lower processing performance. Higher-performance processors tend to consume more power due to several factors related to their architecture, design, and the demands placed on them during operation. One major factor contributing to higher power consumption related to higher performing processing servers is the power consumed in cooling down these processing servers and components therein (e.g., processors). Processing servers in data centers require cooling because they generate significant amounts of heat while operating, and excess heat can negatively affect performance, reliability, and longevity of both the servers and other critical components like storage systems, networking equipment, and power supplies. As higher performance processors perform more work and run at higher speeds, they generate more heat causing more electrical power to be consumed by HVAC solutions to cool the increased thermal output.

Other factors that cause higher performance servers to consume more power include, faster clock speeds, higher core count, higher processor count, higher cache size, or a combination thereof. For example, faster clock speeds associated with a faster processor means that the circuits switch more frequently (higher frequency), which increases dynamic power consumption. In another example, a processor with more cores or more transistors in its design consumes more power, as each additional unit adds to the overall energy requirement. In another example, larger caches and more complex designs (like multiple levels of cache or specialized units like AI accelerators) requires more power. The complexity of the design itself, combined with the need to quickly access large amounts of data, increases the power draw.

Higher performance servers tend to consume higher electrical power even when these servers are processing relatively lighter workloads. For example, a higher-performance server generally consumes more power and generates more heat than a lower-performance server when processing the same workload. This is due to factors like higher clock speeds, more cores, and greater computational capabilities associated with processors employed by the higher-performance servers. While a higher-performance processor of a higher-performance server and a lower-performance processor of a lower-performance server may complete the same task, the higher-performance processor is usually designed to handle much more demanding workloads, which leads to greater power consumption and heat generation. Even for lighter tasks, the higher-performance processor tends to use more resources, such as running at higher clock speeds or using more cores, which leads to increased power draw and heat output. Thus, even if both processors are running the same task (e.g., a simple web browser or word processor), the higher-performance processor will still consume more power and generate more heat because of its more powerful design.

In conventional data centers, software applications or associated tasks needing lower tier processing are often processed by higher tier servers due to several factors including, but not limited to, lack of visibility relating to resource availability across the data center, lack of visibility relating to processing needs of software applications or tasks thereof, excess capacity, and lack of proper resource management and workload distribution. This often causes unnecessary higher power consumption and generation of excessive heat by higher-performance processing servers when the same tasks can be processed by lower-performance processing servers causing relatively lower power consumption and lower heat generation. The higher heat generation causes more electrical power to be consumed by HVAC solutions to cool the increased thermal output of the higher-performance processing servers. Additionally, higher heat often lowers performance of the processors employed by the processing servers due to thermal throttling, component degradation, and thermal limits that are designed to protect the processor and maintain stable operation.

Embodiments of the present disclosure provide technical solutions to the technical problems described above by providing the practical application of providing improved techniques for reducing power consumption in a data center. As described in embodiments of the present disclosure, the disclosed techniques include reducing power consumption related to cooling down data center equipment by proactively detecting data center equipment that can generate excessive heat and, in response, migrating at least a portion of the workload to another data center equipment to avoid the excessive heat generation. The disclosed techniques also include techniques to detect a software application or a software task needing a lower tier processing being processed by a processing server assigned a higher equivalent hardware tier and, in response, migrating the software application or task to another available processing server that is assigned a lower hardware tier, thus saving power.

For example, as described in embodiments of the present disclosure, a controller executes a machine-learning algorithm associated with an AI model to generate a recommendation based on input data fed to the AI model. For example, based on the information relating to software scheduling associated with a first processing server that is fed as part of input data to an AI model, the AI model determines that a software application is scheduled for processing by the first processing server. The AI model identifies that a hardware tier assigned to the first processing server is a higher performance tier-1 and that the software tier assigned to the software application is a lower performance tier-2. In response, the AI model identifies another processing server that is assigned a hardware tier of tier-2 to match the equivalent software tier of the software application and is available to take on processing of the software application. For example, the AI model identifies that a third processing server is assigned a hardware tier of tier 2. Further, based on the software scheduling associated with the third processing server, the AI model determines that the third processing server is available to process the software application. In response to this determination, the AI model generates a recommendation to migrate the processing of the software application from the first processing server to the third processing server. In response to obtaining the recommendation, the controller migrates processing of the software application from the first processing server to the third processing server. Since the hardware tier associated with the third processing server is lower than that of the first processing server, the third processing server consumes less power to processing the software application, thus saving power. Further, since a lower tier third processing server is used to process the software application, lesser heat is generated by the third processing server as compared to the heat output by the first processing server for processing the same software application. Lesser heat generation results in lower overall consumed to cool down the data center.

In another example, after determining that the software application is scheduled for processing by the first processing server, the AI model predicts whether the scheduled processing of the software application by the first processing server is expected to cause the temperature of the first processing server to equal or exceed a threshold temperature configured for the first processing server. For example, based on the temperature measurements (fed as part of input data to the AI model) associated with the first processing server, the AI model determines the most recent temperature measurement at the first processing server. Further, the AI model identifies that the hardware tier assigned to the first processing server is tier-1, and based on the rate of heat value associated with tier-1 processing servers, the AI model estimates heat to be generated by the first processing server for processing the software application. Then, based on the most recent temperature measurement of the first processing server and the estimated heat to be generated by the first processing server, the AI model predicts whether the scheduled processing of the software application by the first processing server is expected to cause the temperature of the first processing server to equal or exceed the threshold temperature configured for the first processing server. For example, when a sum of the value of the most recent temperature measurement and the estimated heat generation value equals or exceeds the threshold temperature, AI model predicts that the scheduled processing of the software application by the first processing server is expected to cause the temperature of the first processing server to equal or exceed the threshold temperature.

In response to this prediction, AI model identifies a second processing server that is assigned the same hardware tier of tier-1 and is also available to process the software application. The AI model generates a recommendation to migrate the processing of the software application or one or more tasks of the software application from the first processing server to the second processing server. In response to obtaining the recommendation, the controller migrates processing of the software application or one or more tasks of the software application from the first processing server to the second processing server.

By keeping the temperature of the first processing server from exceeding its configured threshold temperature, the controller avoids excessive heat from being generated by the first processing server, and thus lowers power consumption associated with cooling down an excessively hot processing server. Further, by avoiding the first processing server from getting excessively hot, the controller avoids the performance of the first processing server from being compromised due to thermal throttling, component degradation, and thermal limits that are designed to protect the processor and maintain stable operation.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure;

FIG. 2 illustrates an example operational diagram for predicting and avoiding performance anomalies in a data center, in accordance with one or more embodiments of the present disclosure;

FIG. 3 illustrates a flowchart of an example method for predicting and avoiding performance anomalies in a data center, in accordance with one or more embodiments of the present disclosure;

FIG. 4 illustrates an example operational diagram for detecting and resolving performance bottlenecks in a data center, in accordance with one or more embodiments of the present disclosure;

FIG. 5 illustrates a flowchart of an example method for detecting and resolving performance bottlenecks in a data center, in accordance with one or more embodiments of the present disclosure;

FIG. 6 illustrates an example operational diagram for determining a remediation process associated with a performance anomaly detected in relation to a data center equipment deployed in a data center, in accordance with one or more embodiments of the present disclosure;

FIG. 7 illustrates a flowchart of an example method for determining a remediation process associated with a performance anomaly detected in relation to a data center equipment deployed in a data center, in accordance with one or more embodiments of the present disclosure;

FIG. 8 illustrates an example operational diagram for reducing power consumption in a data center, in accordance with one or more embodiments of the present disclosure; and

FIG. 9 illustrates a flowchart of an example method for reducing power consumption in a data center, in accordance with one or more embodiments of the present disclosure.

### DETAILED DESCRIPTION

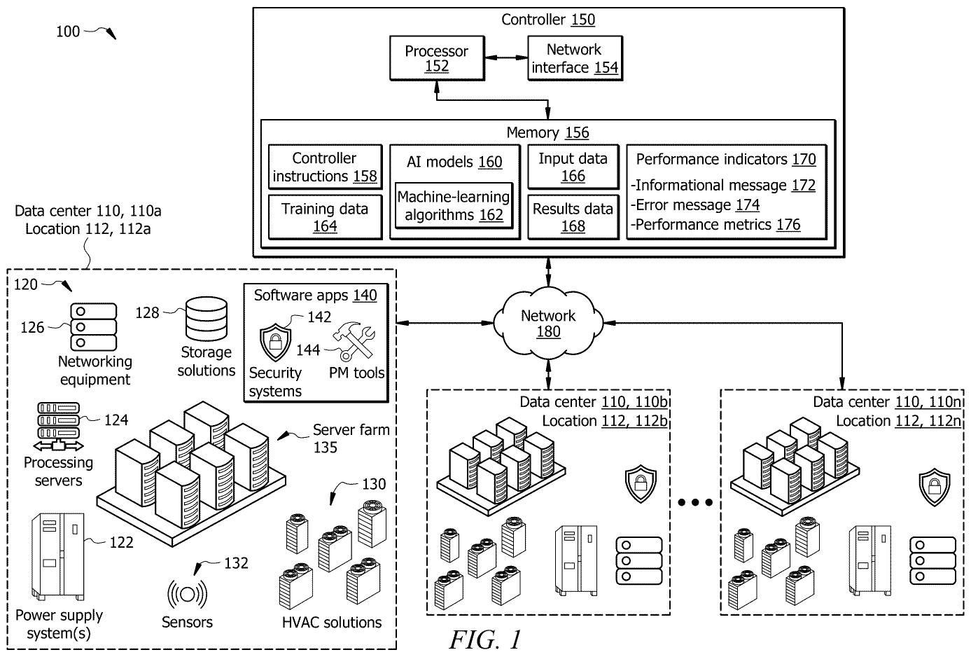

FIG. 1 is a schematic diagram of a system 100, in accordance with certain aspects of the present disclosure. As shown, system 100 includes a plurality of data centers 110 (shown as data centers 110a, 110b, . . . , 110N) and a controller 150 connected to a network 180. Each of the data centers 110 may be located at a different location 112 (shown as locations 112a, 112b, . . . , 112N) such as a different room, different buildings, different towns, different cities, different countries or a combination thereof. A data center 110 generally is a physical room, building or facility that houses Information Technology (IT) infrastructure including hardware and software components to store, manage and process data. Organizations typically use a data center 110 to assemble, process, store and disseminate large amounts of data. An organization typically relies heavily on the applications, services and data contained within a data center 110, making it a critical asset for everyday operations. As shown in FIG. 1, a data center 110 (e.g., data center 110a) may include hardware data center equipment 120 as well as software applications 140 hosted and/or run at one or more of the data center equipment 120. Data center equipment 120 may include, but is not limited to, processing servers 124, storage solutions 128, networking equipment 126, power/energy supply system(s) 122, and heating, ventilation and air conditioning (HVAC) solutions 130.

Processing servers 124 are core processing units that run various software applications 140 and sometimes store data. Storage solutions 128 deployed at a data center 110 typically include several types of storage devices and systems such as traditional hard drives (HDDs), solid-state drives (SSDs), and specialized systems like Storage Area Networks (SANs) or Network-Attached Storage (NAS). Networking equipment 126 generally include switches and routers that facilitate internal communication between data center equipment 120 (e.g., between processing servers 124) as well as external communication between the data center 110 and devices/systems external to the data center 110 (e.g., other data centers 110). Power/energy supply system(s) 122 provide electrical power to various data center equipment 120 and components thereof in a data center 110 such as processing servers 124, networking equipment 126, storage solutions 128 and HVAC solutions 130. Power/energy supply system(s) 122 typically include Uninterruptible Power Supplies (UPS) as well as backup generators to ensure the data center 110 remains operational during power failures. HVAC solutions 130 are essential to maintain optimal temperature conditions for the data center equipment 120 and may include air conditioning systems, liquid cooling systems, and/or other systems employing advanced cooling technologies to avoid and/or prevent overheating of data center equipment 120 (e.g., processing servers 124). As shown in FIG. 1, a data center 110 generally includes a server farm 135 having a plurality of server racks that house several types of data center equipment 120. For example, a server rack may include processing servers, 124, networking equipment 126 (e.g., switches and/or routers), storage solutions 128, power distribution units (PDUs) that distribute electrical power to equipment within a server rack, cables that connect different devices within the rack and other part of the data center 110, patch panels used to organize and manage network cables, cable management system that help keep cables organized and prevent clutter, or combinations thereof.

Software applications 140 that are hosted and run in the data center 110 (e.g., by processing servers 124) may include, but are not limited to, operating systems, virtualization software, management and orchestration software, security software/systems 142, Performance Monitoring tools 144, backup and recovery software, database management systems (DBMS), or a combination thereof.

A data center 110 may employ systems that generate performance indicators 170 indicating performance of various hardware and software components associated with data center 110. Each performance indicator 170 may include, but is not limited to, informational messages 172, error messages 174, recorded values of performance metrics 176, or a combination thereof. An informational message 172 in a data center 110 is a notification that provides details about the current status of a system or component within the data center 110, typically indicating normal operations, non-critical events, or updates without any immediate action required. Essentially, an informational message 172 is a message conveying non-urgent information about the data center's condition and functionality. An error message 174 in a data center 110 is a notification that alerts operators to a problem occurring within the data center infrastructure, such as a server malfunction, network connectivity loss, storage failure, or power supply issue, essentially signaling that something is not functioning as expected and needs attention.

A performance metric 176 associated with a data center 110 is a measurable unit that indicates performance of a data center equipment 120 (or component therein) or a software application 140. Several performance metrics 176 may be monitored and measured in a data center 110 including, but not limited to, temperature associated with a data center equipment 120 (e.g., processing server 124) or a component therein (e.g., CPU), power consumption of a data center equipment 120, humidity, airflow, vibrations, CPU response time, CPU usage, memory usage, error rate, application response time, availability of an application, throughput, network latency, and disk I/O. CPU response time is a measure of the time taken by a CPU to respond to a request. CPU usage is a percentage of processing power utilized by software applications 140 running at a processing server 124 that may highlight potential performance bottlenecks. Memory usage is an amount of memory (e.g., random access memory (RAM)) consumed at a processing server 124. Error rate is a percentage of requests that result in error, signifying application stability and potential anomalies. Application response time indicates the time taken by a software application 140 to respond to a request indicating how quickly the application reacts to interactions. Availability of an application is the percentage of time a software application is operational and accessible to users and systems. Throughput is the number of requests a processing server 124 or a software application can process per unit time (e.g., per second) indicating its capacity to handle traffic. Network latency is the time it takes for data to travel between data center equipment 120. Disk I/O is the rate at which data is read and written to a storage device.

A data center 110 typically employs a combination of hardware sensors 132 and software applications 140 to record the performance metrics 176 associated with the data center 110. Hardware sensors 132 include, but are not limited to, temperature sensors, power sensors that measure power consumption, humidity sensors, differential pressure sensors that monitor airflow by measuring pressure differences between different areas of a data center or data center equipment 120, and vibration sensors. Software applications 140 configured to monitor and record performance metrics 176 may include performance monitoring (PM) tools 144 that are configured to monitor, measure and/or determine several performance metrics 176 associated with the data center 110 such as CPU response time, CPU usage, memory usage, error rate, application response time, availability of an application, throughput, network latency, and disk I/O etc. For example, a performance monitoring tool 144 may determine the CPU response time based on the measured CPU utilization percentage.

Informational messages 172 and error messages 174 may be generated based on the recorded values of one or more performance metrics 176 and may include the recorded values of the one or more performance metrics and other information such as alerts and recommendations.

Network 180, in general, may be a wide area network (WAN), a personal area network (PAN), a cellular network, or any other technology that allows devices to communicate electronically with other devices. In one or more embodiments, network 180 may be the Internet.

As further described in embodiments of the present disclosure, the controller 150 may be configured to perform various operations to improve performance of a data center 110 including optimizing performance of the data center 110 by detecting and resolving performance bottlenecks, predicting and avoiding performance anomalies associated with the data center, optimizing power consumption in the data center 110, and detecting and resolving performance errors associated with the data center 110. While FIG. 1 illustrates the controller 150 as a stand-alone device external to the data center 110, it may be noted that the controller 150 may be implemented within a data center 110 (e.g., by a processing server 124 of the data center 110.

As shown in FIG. 1, the controller 150 includes a processor 152, a memory 156, and a network interface 154. The controller 150 may be configured as shown in FIG. 1 or in any other suitable configuration.

The processor 152 includes one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

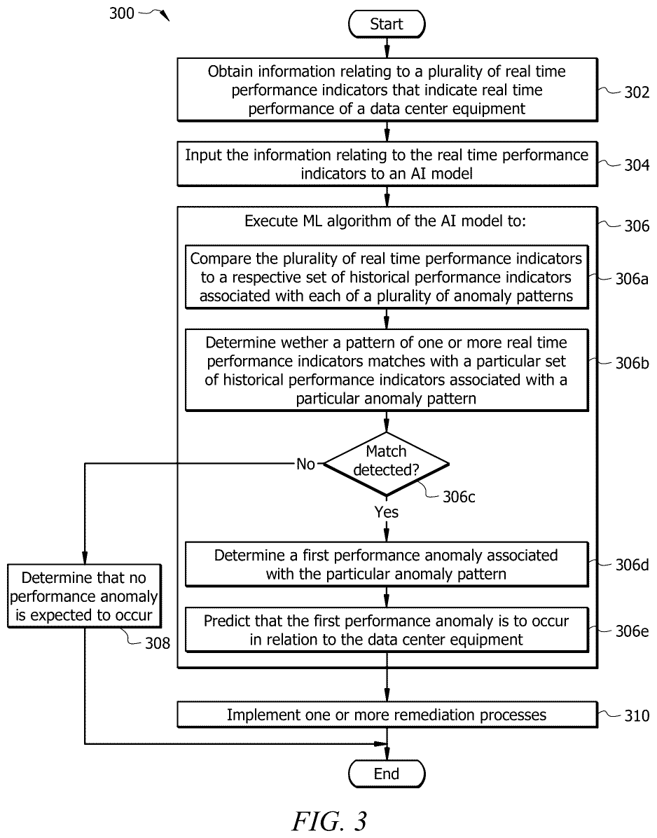

The one or more processors are configured to implement various instructions, such as software instructions. For example, the one or more processors are configured to execute controller instructions 158 to implement the controller 150. In this way, processor 152 may be a special-purpose computer designed to implement the functions disclosed herein. In one or more embodiments, the controller 150 is implemented using logic units, FPGAs, ASICs, DSPs, or any other suitable hardware. The controller 150 is configured to operate as described with reference to FIGS. 1-9. For example, the processor 152 may be configured to perform at least a portion of methods 300, 500, 700, and 900 as described with reference to FIGS. 3, 5, 7, and 9 respectively.

The memory 156 includes a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may include a read-only memory (ROM), random-access memory (RAM), ternary content-addressable memory (TCAM), dynamic random-access memory (DRAM), and static random-access memory (SRAM).

The memory 156 is operable to store the controller instructions 158, one or more Artificial Intelligence (AI) models 160 including machine-learning (ML) algorithms 162 associated with the respective AI models 160, training data 164 used to train the AI models 160, input data 166 input to the AI models 160, results data 168 generated by the AI models 160, and any other data needed to performed operations of the controller 150 as described in embodiments of the present disclosure. The controller instructions 158 may include any suitable set of instructions, logic, rules, or code operable to execute the controller 150.

The network interface 154 is configured to enable wired and/or wireless communications. The network interface 154 is configured to communicate data between the controller 150 and other devices, systems, or domains (e.g., data center equipment 120 such as processing servers 124, network equipment 126, storage solutions, power supply systems 122, HVAC solutions 130, sensors 132 etc.). For example, the network interface 154 may include a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

It may be noted that one or more data center equipment 120 may be implemented like the controller 150 shown in FIG. 1. For example, a data center equipment 120 (e.g., processing server 124, networking equipment 126 etc.) may have a respective processor and a memory that stores data and instructions to perform a respective functionality of the data center equipment 120.

An artificial intelligence (AI) model 160 is a computational framework designed to perform tasks that typically require human intelligence, such as pattern recognition, decision-making, language processing, and problem-solving. AI models 160 are built using algorithms (e.g., machine-learning algorithms 162) that learn from data (e.g., training data 164) to make predictions, classifications, or generate outputs (e.g., result data 168). AI models 160 are often based on machine learning (ML) and deep learning techniques. Each AI model 160 uses at least one machine-learning algorithm 162 that include a set of rules or mathematical functions that guide the AI model 160 to learn from data. Common types of machine-learning algorithms 162 include, but are not limited to, supervised learning algorithms, unsupervised learning algorithms, and reinforcement learning algorithms. In supervised learning, the AI model 160 is trained based on labeled data (e.g., input-output pairs) to learn a mapping. In unsupervised learning, the AI model 160 identifies patterns and structures in unlabeled data. In reinforcement learning, the AI model 160 learns by interacting with an environment and by receiving feedback to fine tune the algorithm.

During a training process, a large amount of data (e.g., training data 164) is fed to the machine-learning algorithm 162 associated with the respective AI model 160, allowing the machine-learning algorithm 162 to learn patterns and relationships with the data so that the AI model 160 can make accurate predictions or classifications on new, unseen data (e.g., input data 166). Essentially, training an AI model 160 or the machine-learning algorithm 162 associated with the AI model 160 is the process of “teaching” the AI how to perform a specific task by exposing it to relevant examples and/or adjusting its internal parameters based on feedback.

### Predicting and Resolving Performance Anomalies in a Data Center

Several performance anomalies can occur in a data center 110 that can adversely affect performance of the data center 110. A “performance anomaly” in a data center 110 generally refers to a significant deviation from the expected, normal operating behavior of a data center equipment 120 such as a processing server 124, network equipment 126, or other system within the data center, often manifesting as a sudden spike or drop in performance metrics like CPU response, CPU usage, memory utilization, network throughput, disk I/O, or application response times indicating a potential issue that needs investigation and troubleshooting. Performance anomalies in a data center 110 can lead to a range of problems including reduced system performance (e.g., reduced processing performance of processing servers 124), application slowdowns, data loss, increased latency, service disruptions, system downtime, reputational damage, and compromised security. Accordingly, it is critical that performance anomalies associated with a data center 110 are avoided to prevent these problems from occurring.

In conventional data centers 110, detecting and resolving performance anomalies can be a challenging task due to a number of technical, operational, and environmental limitations. These limitations can arise from both the complexity of the data center's infrastructure and the nature of the anomaly itself. For example, modern data centers generate vast amounts of performance data (e.g., network traffic, storage usage, CPU/memory utilization, power consumption). Monitoring all of these data streams can overwhelm the monitoring systems and make it difficult to identify true performance issues amidst the noise. For example, performance anomaly detection systems (e.g., performance monitoring tools 144) often produce false positives due to misconfigurations, transient events, or noisy data. When too many alerts are generated, teams may become desensitized to the warnings, making it difficult to distinguish real issues from routine fluctuations. Further, the data center infrastructure includes complex dependencies often consisting of numerous interdependent systems (e.g., compute, storage, networking). Anomalies in one part of the system may propagate to other components, making it hard to pinpoint the root cause. Some monitoring tools lack the granularity necessary to detect anomalies at the level of individual components or workloads. For example, aggregate data might obscure performance problems that only affect a specific server, application, or user. In some cases, monitoring systems may not have full visibility into all layers of the infrastructure (e.g., network devices, virtualized environments, or third-party services), leading to incomplete or inaccurate performance assessments.

Many data centers are reactive in nature, only addressing performance anomalies after they have already impacted users or applications. A proactive approach requires advanced monitoring, trend analysis, and predictive capabilities, which can be difficult to implement effectively. This reactive nature of anomaly detection and resolution means that damage to the data center systems has usually occurred before a performance anomaly is detected and resolved. Further, while anomaly detection systems can alert administrators to performance issues, many require manual intervention to diagnose and resolve. Without adequate automation, this increases the time to resolution and the risk of human error. Some performance issues may escalate quickly (e.g., memory leaks, CPU saturation, or storage exhaustion), and conventional systems for resolving anomalies may not respond fast enough to mitigate the impact on systems, users or applications. As data centers grow, scaling the monitoring infrastructure to handle increased data volume can be challenging. Tools that work well in small environments may struggle to scale effectively in large, distributed data centers.

Embodiments of the present disclosure describe techniques to proactively predict performance anomalies associated with a data center 110 and automatically implement remediation processes to avoid the predicted performance anomalies from occurring.

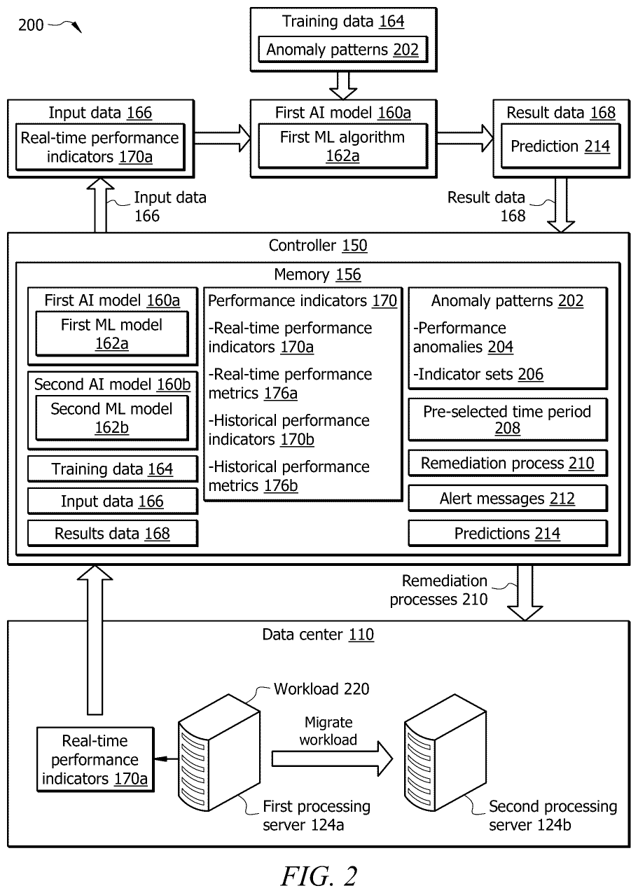

FIG. 2 illustrates an example operational diagram 200 for predicting and avoiding performance anomalies in a data center 110, in accordance with one or more embodiments of the present disclosure. It may be noted that the same components are identified using the same reference numerals across figures referenced in this disclosure.

As shown in FIG. 2, the performance indicators 170 stored by the controller 150 may include real-time performance indicators 170a and historical performance indicators 170b. The real-time performance indicators 170a may include real-time performance metrics 176a. The historical performance indicators 170b may include historical performance metrics 176b. The AI models 160 stored by the controller 150 may include a first AI model 160a and a second AI model 160b, and respective first ML algorithm 162a and second ML algorithm 162b. The controller 150 may further store anomaly patterns 202 including a performance anomaly 204 and an indicator set 206 associated with each anomaly pattern 202. The controller 150 may additionally store a pre-selected time period 208, one or more remediation processes 210 applied or to be applied to avoid and/or resolve performance anomalies 204 in the data center 110, alert messages 212, and predictions 214 generated by the controller 150.

In one or more embodiments, the first AI model 160a is configured/trained to predict performance anomalies 204 that may occur in relation to data center equipment 120 deployed in a data center 110 (e.g., data center 110a). For example, the first AI model 160a may be trained to predict performance anomalies 204 that may occur in relation to a first processing server 124a deployed in the data center 110. As described above, a performance anomaly 204 in a data center 110 generally refers to a significant deviation from the expected, normal operating behavior of a data center equipment 120 such as a processing server 124, network equipment 126, or other system within the data center, often manifesting as a sudden spike or drop in performance metrics like CPU response, CPU usage, memory utilization, network throughput, disk I/O, or application response times indicating a potential issue that needs investigation and troubleshooting. In one embodiment, the controller 150 may be configured to train the first AI model 160a based on a plurality of anomaly patterns 202 associated with the first processing server 124a or a similar processing server 124, to predict a performance anomaly 204 that may occur in relation to the first processing server 124a. As shown in FIG. 2, the training data 164 used to train the first AI model 160 includes anomaly patterns 202 associated with the first processing server 124a or a similar processing server 124. Each anomaly pattern 202 is associated with a particular performance anomaly 204 that was previously detected in relation to the same first processing server 124a or a similar processing server 124 deployed in the data center 110 or any other data center 110 (e.g., data center 110b-110n). A processing server 124 that is similar to the first processing server 124a may include any processing server 124 that has a same or similar hardware configuration (e.g., CPU, memory, network bandwidth etc.) as the first processing server 124a and/or hosts and runs same or similar software applications 140 as the first processing server 124a.

Each anomaly pattern 202 is further associated with an indicator set 206 that includes a set of one or more historical performance indicators 170b that were recorded in a pre-selected time period 208 leading up to the detection of the respective performance anomaly 204 previously detected in relation to the first processing server 124a or a similar processing server. It may be noted that a historical performance indicator 170b is a performance indicator 170 that was previously recorded and stored (in the data center and/or memory 156) in relation to a data center equipment 120. Essentially, the indicator set 206 associated with an anomaly pattern 202 represents a pattern of historical performance indicators 170b associated with a respective previously detected performance anomaly 204. Thus, each anomaly pattern 202 is associated with a particular performance anomaly 204 previously detected in relation to the first processing server 124a (or a similar processing server 124) and an indicator set 206 that represents a pattern of historical performance indicators 170b indicating/identifying the particular performance anomaly 204. The idea here is that if a particular pattern of historical performance indicators 170b (e.g., indicator set 206) was detected leading up to a particular performance anomaly 204 previously detected in relation to a processing server 124, if the same pattern (indicator set 206) of real-time performance indicators 170a is detected in relation to the first processing server 124a, there is a good likelihood that the same performance anomaly 204 may occur in relation to the first processing server 124a.

As described above, a performance indicator 170 may include an informational message 172, an error message 174, a record value of a performance metric 176, or a combination thereof. Thus, an example indicator set 206 may include a combination of one or more informational messages 172, one or more error messages 174, one or more values of performance metrics 176 (e.g., historical performance metrics 176a), or a combination thereof generated/recorded in relation to the first processing server 124 (or similar processing server 124) in the pre-selected time period 208 leading up to detection of a previous performance anomaly 204. For example, an indicator set 206 of an anomaly pattern 202 associated with a previously detected failure of the first processing server 124a or a similar processing server 124 may include two specific informational messages and specific recorded values of CPU response times, CPU usage, memory usage associated with the respective first processing server 124a or the similar processing server 124a.

Once the first AI model 160a is trained, the controller 150 may be configured to execute the first ML algorithm 162a of the first AI model 160a to identify an anomaly pattern 202 in real-time performance indicators 170a fed as input data 166 to the first AI model 160a and generate a prediction 214 of a respective particular performance anomaly 204 that may occur in relation to the first processing server 124a. For example, the controller 150 may be configured to access (e.g., periodically or according to a preconfigured schedule) real-time performance indicators 170a generated/recorded in relation to various data center equipment 120 deployed in the data center 110 and input the real-time performance indicators 170a to the first AI model 160a. Real-time performance indicators 170a include performance indicators 170 associated with the data center 110 (e.g., a data center equipment 120 such as first processing server 124a) that are fed to the first AI model 160a as input data 166 in real-time or near real-time as the performance indicators 170 are generated/recorded. For example, the real-time performance indicators 170a fed as input data 166 to the first AI model 160a may include real-time performance indicators 170a (including recorded values of real-time performance metrics 176a) generated/recorded for the first processing server 124a.

Execution of the first ML algorithm 162a associated with the first AI model 160a causes the first AI model 160a to compare the plurality of real-time performance indicators 170a (from the input data 166) generated/recorded in relation to the first processing server 124a to respective indicator sets 206 of anomaly patterns 202 associated with the first processing server 124a or other processing servers 124 that are similar to the first processing server 124a. In other words, the first AI model 160a compares the real-time performance indicators 170a generated/recorded in relation to the first processing server 124a to indicator sets 206 of historical performance indicators 170b that indicate/identify performance anomalies 204 previously detected in relation to the first processing server 124a or other processing servers 124 that are similar to the first processing server 124a. The goal of this comparison is to determine an anomaly pattern 202 and associated indicator set 206 that matches or closely matches with a respective pattern of real-time performance indicators 170a. Upon determining a pattern of real time performance indicators 170a that matches or closely matches with a particular indicator set 206 of historical performance indicators 170b associated with a particular anomaly pattern 202, the first AI model 160a determines a particular performance anomaly 204 that is associated with the particular anomaly pattern 202 and outputs the particular performance anomaly 204 as a prediction 214. In other words, the first AI model 160a predicts that the particular anomaly 204 is to occur or likely to occur in relation to the first processing server 124a. The idea here is that if a particular pattern of historical performance indicators 170b (e.g., indicator set 206) was detected leading up to a particular performance anomaly 204 previously detected in relation to a the first processing server 124s or a similar processing server 124, when the same pattern (indicator set 206) of real-time performance indicators 170a occurs in relation to the first processing server 124a, there is a good likelihood that the same performance anomaly 204 may occur in relation to the first processing server 124a.

For example, when an indicator set 206 of an anomaly pattern 202 associated with a previously detected failure of the first processing server 124a or a similar processing server 124 includes two specific informational messages and specific recorded values of CPU response times, CPU usage, memory usage associated with the respective first processing server 124a or the similar processing server 124a, and the real-time performance indicators 170a associated with the first processing server 124a also includes the same or similar pattern of the two same or similar informational messages and the same or similar recorded values of CPU response times, CPU usage, memory usage, the first AI model 160a predicts an imminent failure of the first processing server 124a.

In one or more embodiments, upon obtaining a prediction 214 of a performance anomaly 204 based on executing the first ML algorithm 162a of the first AI model 160a, the controller 150 may be configured to automatically implement one or more remediation processes 210 to avoid the predicted performance anomaly 204 from occurring in relation to the first processing server 124a. In one embodiment, the controller 150 may determine which one or more remediation processes 210 is to be implemented depending on the nature of the performance anomaly 204 predicted to occur in relation to the first processing server 124a. For example, in response to obtaining a prediction 214 that the first processing server 124a can fail, the controller 150 may migrate to a second processing server 124b, the processing of a workload 220 or a portion thereof currently processing at the first processing server 124a or scheduled to process at the first processing server 124a. The migration of the workload 220 or a portion there of to the second processing server 124b may ease the processing load on the first processing server 124a and may avoid or prevent the predicted failure from occurring. In another example, when the prediction 214 includes an imminent failure of a particular memory chip of the first processing server 124a, the controller 150 may transfer data stored at the particular memory chip to another memory chip of the first processing server 124a to avoid the predicted failure from occurring. Additionally, or alternatively, the controller 150 may be configured to generate an alert message 212 that indicates that the predicted performance anomaly 204 can occur in relation to the first processing server 124a and other related information such as the real-time performance indicators 170a that matched or nearly matched with an anomaly pattern associated with the predicted performance anomaly 204. The alert message 212 allows a data center technician to investigate the first processing server 124a and apply repairs (if needed) to the first processing server or a component thereof.

In one or more embodiments, the second AI model 160b may be configured/trained to generate the anomaly patterns 202 associated with performance anomalies 204 previously detected in relation to various data center equipment 120 deployed in the data center 110. For example, the second AI model 160 may be trained to generate anomaly patterns 202 associated with performance anomalies 204 previously detected in relation to the first processing server 124a. In one embodiment, in a training phase, the controller 150 may be configured to input to the second AI model 160b as part of training data 164 a plurality of performance indicators 170 that are known to be associated with particular performance anomalies 204 associated with the first processing server 124a. For example, CPU response time and CPU usage may be input as two performance indicators 170 that are known to be associated with a potential failure of a processing server 124.

Once the second AI model 160b is trained, the controller 150 may be configured to execute the second ML algorithm 162b of the second AI model 160b to determine anomaly patterns 202 in historical performance indicators 170b generated/recorded in the pre-selected time period 208 leading up to detection of a respective performance anomaly 204 in relation to the first processing server 124a or other processing servers 124 that are similar to the first processing server 124a. For example, in response to detecting that a particular performance anomaly has occurred in relation to the first processing server 124a or another processing server 124 that is similar to the first processing server 124a, the controller 150 may save (e.g., in memory 156 as historical performance indicators 170b) performance indicators 170 generated/recorded in the pre-selected time period 208 leading up to the detection of the particular performance anomaly 204. The saved historical performance indicators 170b and information relating to the associated particular performance anomaly 204 are fed as input data 166 to the second AI model 160b.

Execution of the second ML algorithm 162b associated with the second AI model 160b causes the second AI model 160b to identify an indicator set 206 of historical performance indicators 170b, based on performance indicators 170 that are known to be associated with the particular performance anomaly 204. The second AI model 160b outputs (e.g., as part of result data 168) the identified indicator set 206 as an anomaly pattern 202 associated with the particular performance anomaly 204. For example, in response to detecting that a processing server 124 that is similar to the first processing server 124a has failed, the controller 150 saves (e.g., in memory 156 as historical performance indicators 170b) performance indicators 170 generated/recorded in the pre-selected time period 208 leading up to the detection of the server failure. The saved historical performance indicators 170b and information relating to the associated server failure are fed as input data 166 to the second AI model 160b. Based on training data 164 indicating that CPU response and CPU usage are indicative of server performance, the second AI model 160b identifies an indicator set including specific values of CPU response and CPU usage recorded leading up to the detecting of the server failure. The identified indicator set 206 is then output as an anomaly pattern 202 associated with failure of the processing server 124.

FIG. 3 illustrates a flowchart of an example method 300 for predicting and avoiding performance anomalies in a data center 110, in accordance with one or more embodiments of the present disclosure. Method 300 may be performed by the controller 150 as shown in FIGS. 1 and 2. Method 300 is described herein with reference to FIG. 2.

At operation 302, the controller 150 obtains information relating to a plurality of real time performance indicators 170a that indicate real time performance of a data center equipment (e.g., first processing server 124a).

As described above, the controller 150 may be configured to access (e.g., periodically or according to a preconfigured schedule) real-time performance indicators 170a generated/recorded in relation to various data center equipment 120 deployed in the data center 110 and input the real-time performance indicators 170a to the first AI model 160a. Real-time performance indicators 170a include performance indicators 170 associated with the data center 110 (e.g., a data center equipment 120 such as first processing server 124a) that are fed to the first AI model 160a as input data 166 in real-time or near real-time as the performance indicators 170 are generated/recorded. For example, the real-time performance indicators 170a fed as input data 166 to the first AI model 160a may include real-time performance indicators 170a (including recorded values of real-time performance metrics 176a) generated/recorded for the first processing server 124a.

At operation 304, the controller 150 inputs the information relating to the real time performance indicators 170a to the AI model 160a. The AI model 160a may be trained based on a plurality of anomaly patterns 202 associated with the data center equipment (e.g., first processing server 124a), to predict a performance anomaly 204 associated with the data center equipment. Each anomaly pattern 202 is associated with a particular performance anomaly 204 previously detected in relation to the data center equipment. Each anomaly pattern 202 comprises a set of historical performance indicators (e.g., indicator set 206) recorded in a pre-selected time period 208 leading up to a respective performance anomaly 204 previously detected in relation to the data center equipment.

As described above, in one or more embodiments, the first AI model 160a is configured/trained to predict performance anomalies 204 that may occur in relation to data center equipment 120 deployed in a data center 110 (e.g., data center 110a). For example, the first AI model 160a may be trained to predict performance anomalies 204 that may occur in relation to a first processing server 124a deployed in the data center 110. As described above, a performance anomaly 204 in a data center 110 generally refers to a significant deviation from the expected, normal operating behavior of a data center equipment 120 such as a processing server 124, network equipment 126, or other system within the data center, often manifesting as a sudden spike or drop in performance metrics like CPU response, CPU usage, memory utilization, network throughput, disk I/O, or application response times indicating a potential issue that needs investigation and troubleshooting. In one embodiment, the controller 150 may be configured to train the first AI model 160a based on a plurality of anomaly patterns 202 associated with the first processing server 124a or a similar processing server 124, to predict a performance anomaly 204 that may occur in relation to the first processing server 124a. As shown in FIG. 2, the training data 164 used to train the first AI model 160 includes anomaly patterns 202 associated with the first processing server 124a or a similar processing server 124. Each anomaly pattern 202 is associated with a particular performance anomaly 204 that was previously detected in relation to the same first processing server 124a or a similar processing server 124 deployed in the data center 110 or any other data center 110 (e.g., data center 110b-110n). A processing server 124 that is similar to the first processing server 124a may include any processing server 124 that has a same or similar hardware configuration (e.g., CPU, memory, network bandwidth etc.) as the first processing server 124a and/or hosts and runs same or similar software applications 140 as the first processing server 124a.

Each anomaly pattern 202 is further associated with an indicator set 206 that includes a set of one or more historical performance indicators 170b that were recorded in a pre-selected time period 208 leading up to the detection of the respective performance anomaly 204 previously detected in relation to the first processing server 124a or a similar processing server. It may be noted that a historical performance indicator 170b is a performance indicator 170 that was previously recorded and stored (in the data center and/or memory 156) in relation to a data center equipment 120. Essentially, the indicator set 206 associated with an anomaly pattern 202 represents a pattern of historical performance indicators 170b associated with a respective previously detected performance anomaly 204. Thus, each anomaly pattern 202 is associated with a particular performance anomaly 204 previously detected in relation to the first processing server 124a (or a similar processing server 124) and an indicator set 206 that represents a pattern of historical performance indicators 170b indicating/identifying the particular performance anomaly 204. The idea here is that if a particular pattern of historical performance indicators 170b (e.g., indicator set 206) was detected leading up to a particular performance anomaly 204 previously detected in relation to a processing server 124, if the same pattern (indicator set 206) of real-time performance indicators 170a is detected in relation to the first processing server 124a, there is a good likelihood that the same performance anomaly 204 may occur in relation to the first processing server 124a.

As described above, a performance indicator 170 may include an informational message 172, an error message 174, a record value of a performance metric 176, or a combination thereof. Thus, an example indicator set 206 may include a combination of one or more informational messages 172, one or more error messages 174, one or more values of performance metrics 176 (e.g., historical performance metrics 176a), or a combination thereof generated/recorded in relation to the first processing server 124 (or similar processing server 124) in the pre-selected time period 208 leading up to detection of a previous performance anomaly 204. For example, an indicator set 206 of an anomaly pattern 202 associated with a previously detected failure of the first processing server 124a or a similar processing server 124 may include two specific informational messages and specific recorded values of CPU response times, CPU usage, memory usage associated with the respective first processing server 124a or the similar processing server 124a.

At operation 306, the controller 150 executes a machine-learning algorithm associated with the AI model to perform a plurality of operations including operations 306A, 306B, 306C, 306D, and 306E to generate a prediction 214.

As described above, once the first AI model 160a is trained, the controller 150 may be configured to execute the first ML algorithm 162a of the first AI model 160a to identify an anomaly pattern 202 in real-time performance indicators 170a fed as input data 166 to the first AI model 160a and generate a prediction 214 of a respective particular performance anomaly 204 that may occur in relation to the first processing server 124a.

At operation 306A, AI model 160a compares the plurality of real time performance indicators 170a to a respective set of historical performance indicators (indicator set 206) associated with each of the plurality of anomaly patterns 202.

At operation 306B, AI model 160a determines whether a pattern of one or more real time performance indicators 170a matches or closely matches with a particular set of historical performance indicators (e.g., indicator set 206) associated with a particular anomaly pattern 202.

As described above, execution of the first ML algorithm 162a associated with the first AI model 160a causes the first AI model 160a to compare the plurality of real-time performance indicators 170a (from the input data 166) generated/recorded in relation to the first processing server 124a to respective indicator sets 206 of anomaly patterns 202 associated with the first processing server 124a or other processing servers 124 that are similar to the first processing server 124a. In other words, the first AI model 160a compares the real-time performance indicators 170a generated/recorded in relation to the first processing server 124a to indicator sets 206 of historical performance indicators 170b that indicate/identify performance anomalies 204 previously detected in relation to the first processing server 124a or other processing servers 124 that are similar to the first processing server 124a. The goal of this comparison is to determine an anomaly pattern 202 and associated indicator set 206 that matches or closely matches with a respective pattern of real-time performance indicators 170a.

At operation 306C, if no pattern of one or more real time performance indicators 170a matches or closely matches with a particular set of historical performance indicators (e.g., indicator set 206) associated with a particular anomaly pattern 202, the method 300 proceeds to operation 308 where the controller 150, based on this determination by the AI model 160a, determines that no performance anomaly 204 is expected to occur at the data center equipment (e.g., first processing server 124a).

On the other hand, if a pattern of one or more real time performance indicators 170a matches or closely matches with a particular set of historical performance indicators (e.g., indicator set 206) associated with a particular anomaly pattern 202, the method 300 proceeds to operation 306D where the AI model 160a determines a first performance anomaly 204 associated with the particular anomaly pattern 202.

At operation 306E, the AI model 160a predicts that the first performance anomaly 204 is to occur in relation to the data center equipment (e.g., first processing server 124a).

As described above, upon determining a pattern of real-time performance indicators 170a that matches or closely matches with a particular indicator set 206 of historical performance indicators 170b associated with a particular anomaly pattern 202, the first AI model 160a determines a particular performance anomaly 204 that is associated with the particular anomaly pattern 202 and outputs the particular performance anomaly 204 as a prediction 214. In other words, the first AI model 160a predicts that the particular anomaly 204 is to occur or likely to occur in relation to the first processing server 124a. The idea here is that if a particular pattern of historical performance indicators 170b (e.g., indicator set 206) was detected leading up to a particular performance anomaly 204 previously detected in relation to a the first processing server 124s or a similar processing server 124, when the same pattern (indicator set 206) of real-time performance indicators 170a occurs in relation to the first processing server 124a, there is a good likelihood that the same performance anomaly 204 may occur in relation to the first processing server 124a.

At operation 310, in response to the prediction of the first performance anomaly 204 in relation to the data center equipment (e.g., first processing server 124a), the controller 150 implements one or more remediation processes 210 to avoid the first performance anomaly 204 from occurring in relation to the data center equipment.

As described above, upon obtaining a prediction 214 of a performance anomaly 204 based on executing the first ML algorithm 162a of the first AI model 160a, the controller 150 may be configured to automatically implement one or more remediation processes 210 to avoid the predicted performance anomaly 204 from occurring in relation to the first processing server 124a.

### Detecting and Resolving Performance Bottlenecks in a Data Center

Several performance bottlenecks can occur in a data center 110 that can adversely affect performance of the data center 110. For example, hardware performance anomalies (e.g., performance anomalies 204 shown in FIG. 2) associated with processing servers 124 can cause performance bottlenecks in the processing of software applications 140 by the processing servers 124 or processing of software applications 140 by other processing servers 124 that are interdependent. Performance bottlenecks in the processing of a software application 140 operating in a data center 110 can occur due to a wide range of factors (e.g., performance anomalies 204 shown in FIG. 2) that affect various components of the application stack, including hardware, software, network, and resource utilization. Identifying and addressing these bottlenecks is critical to maintaining optimal performance and ensuring that users experience fast, reliable services.

Some examples of hardware performance anomalies that often cause performance bottlenecks associated with processing of software applications 140 in a data center 110 include CPU overload, insufficient memory allocation, slow disk read/write speeds on memory disks, insufficient network bandwidth, and high network latency between components of the data center. Performance bottlenecks in software applications 140 can have a significant impact on overall data center performance. Since data centers host and manage multiple software applications and services, any issues within a software application such as slow response times, resource inefficiency, or service failures can cascade throughout the entire system, leading to degraded performance of the data center and components thereof and increased operational challenges. For example, when a software application experiences performance bottlenecks (e.g., slow response times, inefficient code, database contention, or memory leaks), it consumes more resources than expected such as CPU cycles, memory, and disk I/O. This increased resource consumption can strain the data center's physical infrastructure, leading to overloaded processing servers 124. Performance bottlenecks in software applications such as slow database queries, inefficient network calls, or excessive CPU utilization can lead to increased latency in data transmission between servers and storage devices resulting in network congestion and slow service response. In addition, inefficient resource usage because of a software bottleneck can cause higher than normal energy/power consumption for the increased CPU usage and memory usage as well as to cool down the higher amount of heat generated by the overactive computing resources.

Detecting and resolving performance bottlenecks in software applications within a conventional data center can be a complex and challenging process. The limitations faced in identifying and addressing these issues stem from a combination of technical, operational, and environmental factors. For example, in conventional data centers, software applications are often distributed across multiple layers of infrastructure, including servers, storage systems, networking components, and virtualization layers. Performance bottlenecks can occur at any layer, and tracking down the root cause requires a comprehensive understanding of the entire system stack, making detection more complex. Software applications based on microservices architectures introduce additional complexity. Bottlenecks in one service can affect multiple other services that depend on it, making it difficult to isolate the problem. Interdependencies between services, databases, APIs, and external systems complicate the detection and resolution process. Conventional data centers do not have end-to-end visibility into application performance, network condition, database queries, and infrastructure metrics in real-time. Without comprehensive monitoring in place, conventional data centers are unable to detect when and where bottlenecks occur.

Embodiments of the present disclosure overcome the limitations described above by providing techniques for detecting performance bottlenecks occurring in a data center 110 proactively, efficiently and accurately (e.g., in real-time or near real-time) and further automatically implementing remediation processes to alleviate the detected performance bottlenecks.

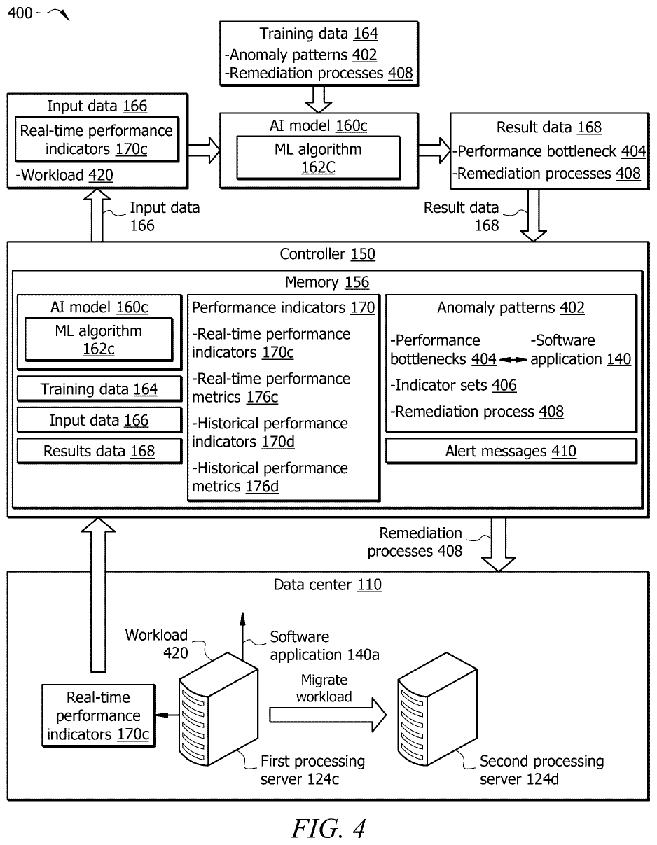

FIG. 4 illustrates an example operational diagram 400 for detecting and resolving performance bottlenecks in a data center 110, in accordance with one or more embodiments of the present disclosure. It may be noted that the same components are identified using the same reference numerals across figures referenced in this disclosure.

As shown in FIG. 4, the performance indicators 170 stored by the controller 150 may include real-time performance indicators 170c and historical performance indicators 170d. The real-time performance indicators 170c may include real-time performance metrics 176c. The historical performance indicators 170d may include historical performance metrics 176d. The AI models 160 stored by the controller 150 may include an AI model 160c and respective ML algorithm 162c. The controller 150 may further store anomaly patterns 402 including a performance bottleneck 404, an indicator set 406, and a remediation process 408 associated with each anomaly pattern 402. The controller 150 may additionally store an alert messages 410 generated by the controller 150.

In one or more embodiments, the AI model 160c is configured/trained to detect performance bottlenecks 404 that occur in the data center 110 and further to automatically resolve detected performance bottlenecks 404 by implementing appropriate remediation processes 408. A performance bottleneck 404 may refer to an anomaly experienced by a software application 140 being processed by a processing server 124 of the data center 110, wherein an anomaly experienced by a software application 140 may include, but is not limited to, slow application response times, unresponsive or hung application, service failures, database contention, sudden slowdowns, unexpected high CPU usage, lagging response times, inconsistent frame rates, network latency spikes, database query timeouts, memory leaks, excessive disk I/O, application crashes under load, and erratic application performance. As described above, a performance bottleneck 404 associated with a software application 140 is often caused by hardware performance anomalies (e.g., performance anomalies 204 shown in FIG. 2) associated with processing servers 124 processing the software application 140 or other data center equipment 120 involved in processing the software application 140. Some examples of hardware performance anomalies that can cause performance bottlenecks 404 associated with processing of software applications 140 in a data center 110 include CPU overload, insufficient memory allocation, slow disk read/write speeds on memory disks, insufficient network bandwidth, and high network latency between components of the data center 110.

In one example, the AI model 160c may be trained to detect/determine a performance bottleneck 404 experienced by a software application 140a being processed by a first processing server 124c deployed in the data center 110. In one embodiment, the software application 140a may be part of a workload 420 being processed by the first processing server 124c. In one embodiment, the controller 150 may be configured to train the AI model 160c based on a plurality of anomaly patterns 402 associated with the first processing server 124c or a similar processing server 124, to determine a performance bottleneck 404 experienced by a software application 140a being processed by the first processing server 124c. As shown in FIG. 4, the training data 164 used to train the AI model 160c includes anomaly patterns 402 associated with the first processing server 124c or a similar processing server 124. Each anomaly pattern 202 is associated with a particular performance bottleneck 404 that was previously detected in relation to a respective software application 140 processed by the same first processing server 124c or a similar processing server 124 deployed in the data center 110 or any other data center 110 (e.g., data center 110b-110n). A processing server 124 that is similar to the first processing server 124c may include any processing server 124 that has a same or similar hardware configuration (e.g., CPU, memory, network bandwidth etc.) as the first processing server 124c and/or hosts and runs same or similar workload 420 as the first processing server 124c. The term “workload 420” refers to one or more software applications 140 being processed by the first processing server 124c.

Each anomaly pattern 402 is further associated with an indicator set 406 that includes a set of one or more historical performance indicators 170d that were recorded in relation to a respective performance bottleneck 404 previously detected in relation to a respective software application 140 (e.g., software application 140a) processed by the first processing server 124c or a similar processing server 124. It may be noted that a historical performance indicator 170d is a performance indicator 170 that was previously recorded and stored (in the data center 110 and/or memory 156) in relation to a data center equipment 120 (e.g., processing server 124). Essentially, the indicator set 406 associated with an anomaly pattern 402 represents a pattern of historical performance indicators 170d recorded for the first processing server 124c (or a similar processing server 124) that caused or likely caused a respective previously detected performance bottleneck 404 associated with a respective software application 140. Thus, each anomaly pattern 402 is associated with a particular performance bottleneck 404 previously detected in relation to a particular software application 140 processed by the first processing server 124c (or a similar processing server 124) and an indicator set 406 that represents a pattern of historical performance indicators 170d indicating/identifying the particular performance bottleneck 404. The idea here is that if a particular pattern of historical performance indicators 170d (e.g., indicator set 406) was detected in relation to a particular performance bottleneck 404 previously detected in relation to a particular software application 140 processed by a processing server 124, then if the same or similar pattern (indicator set 406) of real-time performance indicators 170c is detected in relation to the first processing server 124c when processing the same or similar particular software application 140, there is a good likelihood that the same performance bottleneck 404 may have occurred in relation to the particular software application 140.

As described above, a performance indicator 170 may include an informational message 172, an error message 174, a record value of a performance metric 176, or a combination thereof. Thus, an example indicator set 406 may include a combination of one or more informational messages 172, one or more error messages 174, one or more values of performance metrics 176 (e.g., historical performance metrics 176d), or a combination thereof generated/recorded in relation to the first processing server 124c (or similar processing server 124) at the time of detection of a previous performance bottleneck 404 associated with a respective software application 140. For example, an indicator set 406 of an anomaly pattern 402 associated with the first processing server 124c or a similar processing server 124 that processed the software application 140a may include specific recorded values of CPU response times, CPU usage, memory usage that were recorded in response to or at the time of detecting an unresponsive software application 140a. For example, the recorded values may include low CPU response times, high CPU usage and high memory usage that caused the software application 140a to be unresponsive.

In one or more embodiments, the controller 150 may be configured to additionally train the AI model 160c based on remediation processes 408 associated with respective anomaly patterns 402, to determine a remediation process 408 that can be implemented to resolve a performance bottleneck 404 detected (e.g., by the AI model 160c) in relation to a software application 140 (e.g., software application 140a) processed by the first processing server 124c. A remediation process 408 associated with a respective anomaly pattern 402 is a remediation process 408 that was implemented to resolve a respective performance bottleneck 404 associated with the anomaly pattern 402. As shown in FIG. 4, the training data 164 used to train the AI model 160c includes remediation processes 408 associated with the respective anomaly patterns 402 associated with the first processing server 124c or a similar processing server 124.

In an additional or alternative embodiment, each anomaly pattern 402 associated with the first processing server 124c or a similar processing server 124 may include information relating to a respective workload 420 being processing by the first processing server 124c or a similar processing server 124 when the associated performance bottleneck 404 was detected in relation to the respective software application 140.

Once the AI model 160c is trained, the controller 150 may be configured to execute the ML algorithm 162c of the AI model 160c to identify an anomaly pattern 402 in real-time performance indicators 170c fed as input data 166 to the AI model 160c and determine whether a performance bottleneck 404 has occurred in relation to the software application 140a processed by or actively being processed by the first processing server 124c. For example, the controller 150 may be configured to access (e.g., periodically or according to a preconfigured schedule) real-time performance indicators 170c generated/recorded in relation to various data center equipment 120 deployed in the data center 110 and input the real-time performance indicators 170c to the AI model 160c. Real-time performance indicators 170c include performance indicators 170 associated with the data center 110 (e.g., a data center equipment 120 such as first processing server 124c) that are fed to the AI model 160c as input data 166 in real-time or near real-time as the performance indicators 170 are generated/recorded. For example, the real-time performance indicators 170c fed as input data 166 to the AI model 160c may include real-time performance indicators 170c (including recorded values of real-time performance metrics 176c) generated/recorded for the first processing server 124c.

Execution of the ML algorithm 162c associated with the AI model 160c causes the AI model 160c to compare the plurality of real-time performance indicators 170c (from the input data 166) generated/recorded in relation to the first processing server 124c to respective indicator sets 406 of anomaly patterns 402 associated with the first processing server 124c or other processing servers 124 that are similar to the first processing server 124c. In other words, the AI model 160c compares the real-time performance indicators 170c generated/recorded in relation to the first processing server 124c to indicator sets 406 of historical performance indicators 170d that indicate/identify performance bottlenecks 404 previously detected in relation to the software application 140a (or a similar software application 140) processed by the first processing server 124c or other processing servers 124 that are similar to the first processing server 124c. The goal of this comparison is to determine an anomaly pattern 402 and associated indicator set 406 that matches or closely matches with a respective pattern of real-time performance indicators 170c. Upon determining a pattern of real time performance indicators 170c that matches or closely matches with a particular indicator set 406 of historical performance indicators 170d associated with a particular anomaly pattern 402, the AI model 160c determines a particular performance bottleneck 404 that is associated with the particular anomaly pattern 402 and outputs the particular performance bottleneck 404 as part of result data 168. In other words, the AI model 160c determines that the particular performance bottleneck 404 has occurred in relation to the software application 140a processed or being processed by first processing server 124c. The idea here is that if a particular pattern of historical performance indicators 170d (e.g., indicator set 406) was detected in relation to a particular performance bottleneck 404 previously detected in relation to the software application 140a or a similar software application 140 processed by the first processing server 124c or a similar processing server 124, then when the same or similar pattern (indicator set 406) of real-time performance indicators 170c is detected in relation to the first processing server 124c when processing the same or similar software application 140a, there is a good likelihood that the same performance bottleneck 404 may have occurred in relation to the software application 140a.

For example, when an indicator set 406 of an anomaly pattern 402 associated with unresponsive software application 140a or unresponsive similar software application 140 (e.g., similar to the first software application 140a) at the first processing server 124c or a similar processing server 124 includes specific recorded values of CPU response times, CPU usage, and memory usage that were recorded in response to or at the time of detecting the unresponsive software application 140a or the unresponsive similar software application 140, and the real time performance indicators 170c associated with the first processing server 124c also includes the same or similar pattern of the same or similar values of CPU response times, CPU usage, and memory usage, the AI model 160c determines that the software application 140a is unresponsive at the first processing server 124c.

In one or more embodiments, the input data 166 fed to the AI model 160c may additionally include a current workload 420 being processed by the first processing server 124c at the time the real-time performance indicators 170c are recorded. As described above, the term “workload 420” generally refers to one or more software applications 140 being processed by a particular processing server 124. For example, the software application 140a may be part of a workload 420 being processed by the first processing server 124c. In one example, the first software application 140a may be a security monitoring tool and the workload 420 being processed by the first processing server 124c may include the security monitoring tool being processed simultaneously with a second software application (not shown) that is a performance management tool. In one embodiment, execution of the ML algorithm 162c may cause the AI model 160c to compare the real-time performance indicators 170c to respective indicator sets 406 of only those anomaly patterns 402 associated with the first processing server 124c (or similar processing servers 124) where the respective indicator sets 406 were recorded while the first processing server 124c or similar processing servers 124 were processing the same workload 420 or a similar workload 420 as is being processed by the first processing server 124c. In other words, the real-time performance indicators 170c are compared with only those indicator sets 406 that were recorded when the respective processing servers 124 were processing the same workload 420 or a similar workload 420 as is being processed by the first processing server 124c. This raises the accuracy of detecting the performance bottlenecks 404.

In one or more embodiments, upon obtaining a determination of a performance bottleneck 404 associated with the software application 140a (e.g., as part of result data 168) based on executing the ML algorithm 162c of the AI model 160c, the controller 150 may be configured to automatically implement one or more remediation processes 408 to resolve the performance bottleneck 404 in relation to the software application 140a. In one embodiment, in addition to the determination that the performance bottleneck 404 has occurred in relation to the software application 140a, AI model 160c may additionally output (e.g., as part of the result data 168) a remediation process 408 associated with the respective anomaly pattern 402 that matched or closely matched with the real-time performance indicators 170c. In other words, the AI model 160c outputs information relating to the remediation process 408 that was implemented to resolve the previously detected performance bottleneck 404 associated with the matching anomaly pattern 402. The controller 150 may be configured to automatically implement the remediation process 408 obtained as part of result data 168, to resolve the detected performance bottleneck 404 associated with the software application 140a. The idea here is that if a particular remediation process 408 previously resolved a performance bottleneck 404 relating to the software application 140a or a similar software application 140, then the same remediation process 408 would most likely resolve the same performance bottleneck 404 when it occurs at a subsequent time in relation to the software application 140a.

In one embodiment, the remediation process 408 implemented to resolve the detected performance bottleneck 404 relating to the software application 140a includes migrating processing of the workload 420 or a portion thereof being processed by the first processing server 124c or scheduled to be processed by the first processing server 124c to a second processing server 124d. The migration of the workload 420 or a portion there of to the second processing server 124d may ease the processing load on the first processing server 124c and may resolve the detected performance bottleneck at the first processing server 124c. For example, when the performance bottleneck 404 detected in relation to the software application 140a was caused due to high CPU usage, then migrating at least a portion of the workload 420 to the second processing server 124d may ease the CPU load at the first processing server 124c and may resolve the performance bottleneck 404.

Additionally, or alternatively, the controller 150 may be configured to generate an alert message 410 that indicates that the performance bottleneck 404 has occurred in relation to the software application 140a at the first processing server 124c and other related information such as the real-time performance indicators 170c that matched or nearly matched with an anomaly pattern 402 associated with the determined performance bottleneck 404. The alert message 212 allows a data center technician to investigate the first processing server 124c and apply repairs (if needed) to the first processing server 124c or a component thereof to resolve the detected performance bottleneck 404.

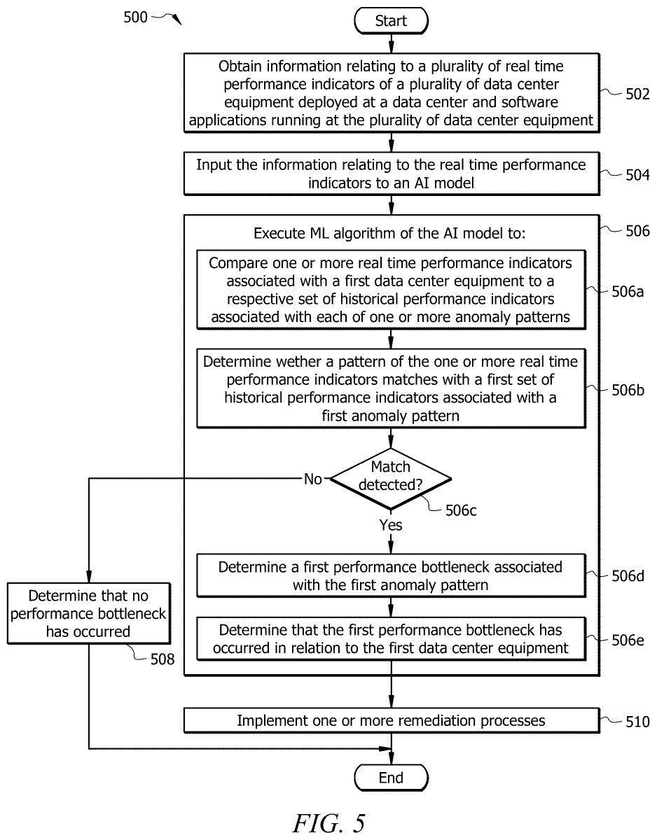

FIG. 5 illustrates a flowchart of an example method 500 for detecting and resolving performance bottlenecks in a data center 110, in accordance with one or more embodiments of the present disclosure. Method 500 may be performed by the controller 150 as shown in FIGS. 1 and 4. Method 500 is described herein with reference to FIG. 4.

At operation 502, controller 150 obtains information relating to a plurality of real time performance indicators 170c that indicate real time performance of a plurality of data center equipment 120 deployed at a data center 110 and software applications 140 running at the plurality of data center equipment 120.

As described above, the controller 150 may be configured to access (e.g., periodically or according to a preconfigured schedule) real-time performance indicators 170c generated/recorded in relation to various data center equipment 120 deployed in the data center 110 and input the real-time performance indicators 170c to the AI model 160c. Real-time performance indicators 170c include performance indicators 170 associated with the data center 110 (e.g., a data center equipment 120 such as first processing server 124c) that are fed to the AI model 160c as input data 166 in real-time or near real-time as the performance indicators 170 are generated/recorded. For example, the real-time performance indicators 170c fed as input data 166 to the AI model 160c may include real-time performance indicators 170c (including recorded values of real-time performance metrics 176c) generated/recorded for the first processing server 124c.

At operation 504, controller 150 inputs the information relating to the real time performance indicators 170c to the AI model 160c. The AI model 160c is trained based on a plurality of anomaly patterns 402 associated with the data center 110, to determine that a performance bottleneck 404 has occurred in relation to one of the plurality of data center equipment 120 (e.g., first processing server 124c). Each anomaly pattern 402 is associated with a particular performance bottleneck 404 previously detected in relation to a data center equipment 120 and comprises a set of historical performance indicators (e.g., indicator set 406) recorded in relation to the data center equipment 120 and that are associated with the particular performance bottleneck 404.

As described above, the AI model 160c is configured/trained to detect performance bottlenecks 404 that occur in the data center 110 and further to automatically resolve detected performance bottlenecks 404 by implementing appropriate remediation processes 408. A performance bottleneck 404 may refer to an anomaly experienced by a software application 140 being processed by a processing server 124 of the data center 110, wherein an anomaly experienced by a software application 140 may include, but is not limited to, slow application response times, unresponsive or hung application, service failures, database contention, sudden slowdowns, unexpected high CPU usage, lagging response times, inconsistent frame rates, network latency spikes, database query timeouts, memory leaks, excessive disk I/O, application crashes under load, and erratic application performance. As described above, a performance bottleneck 404 associated with a software application 140 is often caused by hardware performance anomalies (e.g., performance anomalies 204 shown in FIG. 2) associated with processing servers 124 processing the software application 140 or other data center equipment 120 involved in processing the software application 140. Some examples of hardware performance anomalies that can cause performance bottlenecks 404 associated with processing of software applications 140 in a data center 110 include CPU overload, insufficient memory allocation, slow disk read/write speeds on memory disks, insufficient network bandwidth, and high network latency between components of the data center 110.

In one example, the AI model 160c may be trained to detect/determine a performance bottleneck 404 experienced by a software application 140a being processed by a first processing server 124c deployed in the data center 110. In one embodiment, the software application 140a may be part of a workload 420 being processed by the first processing server 124c. In one embodiment, the controller 150 may be configured to train the AI model 160c based on a plurality of anomaly patterns 402 associated with the first processing server 124c or a similar processing server 124, to determine a performance bottleneck 404 experienced by a software application 140a being processed by the first processing server 124c. As shown in FIG. 4, the training data 164 used to train the AI model 160c includes anomaly patterns 402 associated with the first processing server 124c or a similar processing server 124. Each anomaly pattern 202 is associated with a particular performance bottleneck 404 that was previously detected in relation to a respective software application 140 processed by the same first processing server 124c or a similar processing server 124 deployed in the data center 110 or any other data center 110 (e.g., data center 110b-110n). A processing server 124 that is similar to the first processing server 124c may include any processing server 124 that has a same or similar hardware configuration (e.g., CPU, memory, network bandwidth etc.) as the first processing server 124c and/or hosts and runs same or similar workload 420 as the first processing server 124c. The term “workload 420” refers to one or more software applications 140 being processed by the first processing server 124c.

Each anomaly pattern 402 is further associated with an indicator set 406 that includes a set of one or more historical performance indicators 170d that were recorded in relation to a respective performance bottleneck 404 previously detected in relation to a respective software application 140 (e.g., software application 140a) processed by the first processing server 124c or a similar processing server 124. It may be noted that a historical performance indicator 170d is a performance indicator 170 that was previously recorded and stored (in the data center 110 and/or memory 156) in relation to a data center equipment 120 (e.g., processing server 124). Essentially, the indicator set 406 associated with an anomaly pattern 402 represents a pattern of historical performance indicators 170d recorded for the first processing server 124c (or a similar processing server 124) that caused or likely caused a respective previously detected performance bottleneck 404 associated with a respective software application 140. Thus, each anomaly pattern 402 is associated with a particular performance bottleneck 404 previously detected in relation to a particular software application 140 processed by the first processing server 124c (or a similar processing server 124) and an indicator set 406 that represents a pattern of historical performance indicators 170d indicating/identifying the particular performance bottleneck 404. The idea here is that if a particular pattern of historical performance indicators 170d (e.g., indicator set 406) was detected in relation to a particular performance bottleneck 404 previously detected in relation to a particular software application 140 processed by a processing server 124, then if the same or similar pattern (indicator set 406) of real-time performance indicators 170c is detected in relation to the first processing server 124c when processing the same or similar particular software application 140, there is a good likelihood that the same performance bottleneck 404 may have occurred in relation to the particular software application 140.

As described above, a performance indicator 170 may include an informational message 172, an error message 174, a record value of a performance metric 176, or a combination thereof. Thus, an example indicator set 406 may include a combination of one or more informational messages 172, one or more error messages 174, one or more values of performance metrics 176 (e.g., historical performance metrics 176d), or a combination thereof generated/recorded in relation to the first processing server 124c (or similar processing server 124) at the time of detection of a previous performance bottleneck 404 associated with a respective software application 140. For example, an indicator set 406 of an anomaly pattern 402 associated with the first processing server 124c or a similar processing server 124 that processed the software application 140a may include specific recorded values of CPU response times, CPU usage, memory usage that were recorded in response to or at the time of detecting an unresponsive software application 140a. For example, the recorded values may include low CPU response times, high CPU usage and high memory usage that caused the software application 140a to be unresponsive.

In one or more embodiments, the controller 150 may be configured to additionally train the AI model 160c based on remediation processes 408 associated with respective anomaly patterns 402, to determine a remediation process 408 that can be implemented to resolve a performance bottleneck 404 detected (e.g., by the AI model 160c) in relation to a software application 140 (e.g., software application 140a) processed by the first processing server 124c. A remediation process 408 associated with a respective anomaly pattern 402 is a remediation process 408 that was implemented to resolve a respective performance bottleneck 404 associated with the anomaly pattern 402. As shown in FIG. 4, the training data 164 used to train the AI model 160c includes remediation processes 408 associated with the respective anomaly patterns 402 associated with the first processing server 124c or a similar processing server 124.

In an additional or alternative embodiment, each anomaly pattern 402 associated with the first processing server 124c or a similar processing server 124 may include information relating to a respective workload 420 being processing by the first processing server 124c or a similar processing server 124 when the associated performance bottleneck 404 was detected in relation to the respective software application 140.

At operation 506, controller 150 executes the machine-learning algorithm 162c to perform a plurality of operations including operations 506A, 506B, 506C, 506D, and 506E to at least determine whether a performance bottleneck 404 has occurred in the data center 110.

As described above, once the AI model 160c is trained, the controller 150 may be configured to execute the ML algorithm 162c of the AI model 160c to identify an anomaly pattern 402 in real-time performance indicators 170c fed as input data 166 to the AI model 160c and determine whether a performance bottleneck 404 has occurred in relation to the software application 140a processed by or actively being processed by the first processing server 124c.

At operation 506A, the AI model 160c compares one or more real time performance indicators 170c associated with a first data center equipment (e.g., first processing server 124c) to a respective set of historical performance indicators (e.g., indicator set 406) associated with each of one or more anomaly patterns 402.

At operation 506B, the AI model 160c determines whether a pattern of at least a portion of the one or more real time performance indicators 170c recorded for the first data center equipment (e.g., first processing server 124c) matches with or closely matches with a corresponding set of historical performance indicators 170d associated with an anomaly pattern 402.

As described above, execution of the ML algorithm 162c associated with the AI model 160c causes the AI model 160c to compare the plurality of real-time performance indicators 170c (from the input data 166) generated/recorded in relation to the first processing server 124c to respective indicator sets 406 of anomaly patterns 402 associated with the first processing server 124c or other processing servers 124 that are similar to the first processing server 124c. In other words, the AI model 160c compares the real-time performance indicators 170c generated/recorded in relation to the first processing server 124c to indicator sets 406 of historical performance indicators 170d that indicate/identify performance bottlenecks 404 previously detected in relation to the software application 140a (or a similar software application 140) processed by the first processing server 124c or other processing servers 124 that are similar to the first processing server 124c. The goal of this comparison is to determine an anomaly pattern 402 and associated indicator set 406 that matches or closely matches with a respective pattern of real-time performance indicators 170c.

At operation 506C, if no pattern of at least a portion of the one or more real time performance indicators 170c recorded for the first data center equipment (e.g., first processing server 124c) matches with or closely matches with a corresponding set of historical performance indicators (e.g., indicator set 406) associated with an anomaly pattern 402, the method 500 proceeds to operation 508 where the controller 150, based on the AI model's determination, determines that no performance bottleneck 404 has occurred in the data center 110.

On the other hand, if a first pattern of at least a portion of the one or more real time performance indicators 170c recorded for the first data center equipment (e.g., first processing server 124c) matches with or closely matches with a first set of historical performance indicators (e.g., indicator set 406) associated with a first anomaly pattern 402, the method 500 proceeds to operation 506D where the AI model 160c determines a first performance bottleneck 404 associated with the first anomaly pattern 402.

At operation 506E, the AI model 160c determines that the first performance bottleneck 404 has occurred in relation to the first data center equipment (e.g., first processing server 124c).

As described above, upon determining a pattern of real-time performance indicators 170c that matches or closely matches with a particular indicator set 406 of historical performance indicators 170d associated with a particular anomaly pattern 402, the AI model 160c determines a particular performance bottleneck 404 that is associated with the particular anomaly pattern 402 and outputs the particular performance bottleneck 404 as part of result data 168. In other words, the AI model 160c determines that the particular performance bottleneck 404 has occurred in relation to the software application 140a processed or being processed by first processing server 124c. The idea here is that if a particular pattern of historical performance indicators 170d (e.g., indicator set 406) was detected in relation to a particular performance bottleneck 404 previously detected in relation to the software application 140a or a similar software application 140 processed by the first processing server 124c or a similar processing server 124, then when the same or similar pattern (indicator set 406) of real-time performance indicators 170c is detected in relation to the first processing server 124c when processing the same or similar software application 140a, there is a good likelihood that the same performance bottleneck 404 may have occurred in relation to the software application 140a.

At operation 510, in response to the prediction of the first performance bottleneck 404 in relation to the first data center equipment (e.g., first processing server 124c), controller 150 implements one or more remediation processes 408 to resolve the first performance bottleneck 404 associated with the first data center equipment (e.g., first processing server 124c).

### Troubleshooting Performance Anomalies in a Data Center

Finding a resolution to a performance anomaly in a data center can be a complex and challenging task. Performance issues often result from a variety of underlying causes, and identifying the root cause requires a deep understanding of both the infrastructure and workload patterns. A conventional data center faces several technical problems when diagnosing and resolving performance anomalies. A modern data center typically consists of many different components, including servers, storage systems, networking equipment, virtualization layers, and external services. A performance issue in one part of the system may affect others in unpredictable ways, making it difficult to pinpoint the exact source of the anomaly making it difficult to determine an apply a proper resolution. Data centers generate massive amounts of performance and operational data. Logs, metrics, and traces are produced continuously by various systems, and analyzing this data in real-time or retroactively to detect what caused a particular performance anomaly can be overwhelming. Often different instances of a same type of performance anomaly can be caused by different reasons. Thus, a remediation method to be applied to resolve each performance anomaly depends on what caused the anomaly. Conventional data centers are often unable to accurately detect a cause of a performance anomaly. Performance anomalies can be caused by many different factors, including hardware failures, software bugs, configuration issues, network problems, or external factors (e.g., DDoS attacks or third-party service outages). Identifying the root cause requires analyzing data from multiple layers and sources, which can be time-consuming and error prone.

In many cases, diagnosing a performance anomaly involves manually reviewing logs, metrics, and traces, which can be very time-consuming, especially when the issue spans across multiple components. Even with automated monitoring tools, isolating the root cause can still take a considerable amount of time, during which the problem may persist or worsen. Delaying the resolution of a performance anomaly in a data center can have a range of negative consequences, many of which can escalate over time. For example, a performance anomaly that is not addressed promptly can evolve into a system failure, causing longer periods of downtime or service disruptions. Performance issues often have a ripple effect across the data center infrastructure. For instance, a slow network or overloaded storage system can cause delays or failures in other systems, leading to a cascading failure that may involve multiple components and services. Additionally, unresolved performance anomalies, such as slow storage or network performance, can result in higher latency for end-users and customers.

Embodiments of the present disclosure overcome the limitations described above by providing improved techniques for accurately diagnosing a performance anomaly detected in relation to a data center equipment and determining an appropriate remediation process to resolve performance anomaly.

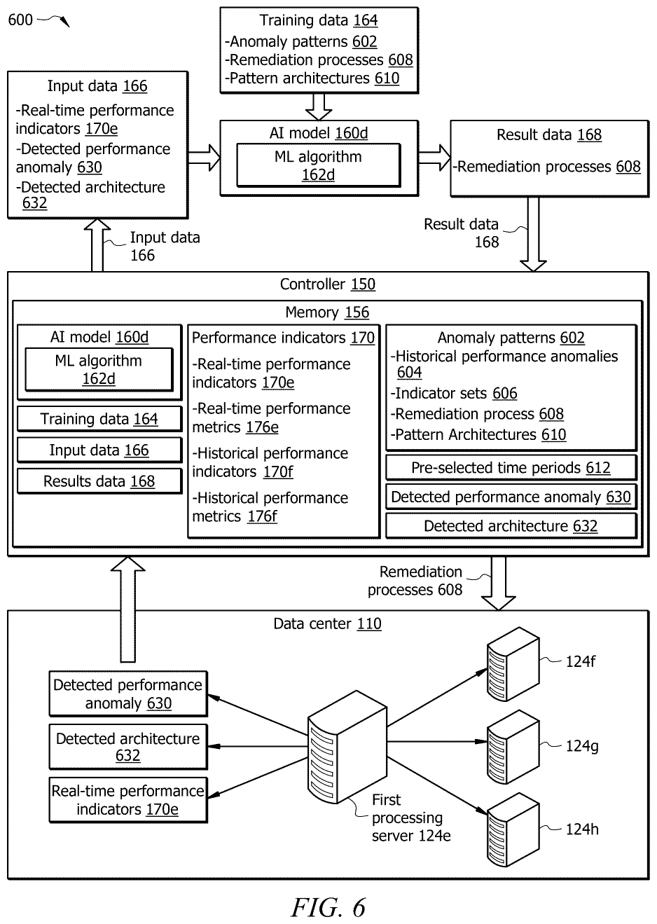

FIG. 6 illustrates an example operational diagram 600 for determining a remediation process associated with a performance anomaly detected in relation to a data center equipment 120 deployed in a data center 110, in accordance with one or more embodiments of the present disclosure. It may be noted that the same components are identified using the same reference numerals across figures referenced in this disclosure.

As shown in FIG. 4, the performance indicators 170 stored by the controller 150 may include real-time performance indicators 170e and historical performance indicators 170f. The real-time performance indicators 170e may include real-time performance metrics 176e. The historical performance indicators 170f may include historical performance metrics 176f. The AI models 160 stored by the controller 150 may include an AI model 160f and respective ML algorithm 162d. The controller 150 may further store a detected performance anomaly 620 in relation to a data center equipment 120 (e.g., first processing server 124e), detected architecture 632 associated with the data center equipment 120 (e.g., first processing server 124e) that experienced the detected performance anomaly 630, anomaly patterns 602 including a historical performance anomaly 604, an indicator set 606, a remediation process 608, and a pattern architecture 610 associated with each anomaly pattern 602. The controller 150 may additionally store one or more pre-selected time periods 612.

In one or more embodiments, the AI model 160d is configured/trained to determine one or more remediation processes 608 to resolve detected performance anomalies 630 that occur in the data center 110 and further to automatically resolve the detected performance anomalies 630 by implementing the one or more remediation processes 608. As described above, a performance anomaly in a data center 110 generally refers to a significant deviation from the expected, normal operating behavior of a data center equipment 120 such as a processing server 124, network equipment 126, or other system within the data center 110, often manifesting as a sudden spike or drop in performance metrics like CPU response, CPU usage, memory utilization, network throughput, disk I/O, or application response times indicating a potential issue that needs investigation and troubleshooting. In one or more embodiments, the controller 150 may be configured to monitor a plurality of data center equipment 120 deployed in the data center 110 and detect when a particular piece of data center equipment 120 has experienced a performance anomaly. For example, the controller 150 may be configured to detect when the first processing server 124e experiences a performance anomaly. The performance anomaly detected in relation to a data center equipment 120 (e.g., first processing server 124e) is herein referred to as detected performance anomaly 630.

In one example, the AI model 160d may be trained to determine a remediation process 608 to resolve a detected performance anomaly 630 in relation to the first processing server 124e deployed in the data center 110. In one embodiment, the controller 150 may be configured to train the AI model 160d based on a plurality of anomaly patterns 602 associated with a plurality of data center equipment 120 deployed across a plurality of data centers 110 (e.g., data centers 110a, 110b, . . . 110n as shown in FIG. 1). These anomaly patterns 602 may include anomaly patterns 602 associated with the first processing server 124e or similar processing servers 124 deployed across the plurality of data centers 110. As shown in FIG. 4, the training data 164 used to train the AI model 160d includes the anomaly patterns 602. Each anomaly pattern 602 is associated with a particular historical performance anomaly 604 that was previously detected in relation to a particular data center equipment 120 deployed at a particular data center 110. For example, one or more anomaly patterns 602 are associated with historical performance anomalies 604 that were previously detected in relation to the first processing server 124e or other processing servers 124 across multiple data centers 110 that are similar to the first processing server 124e. A processing server 124 that is similar to the first processing server 124e may include any processing server 124 deployed at any one of the plurality of data centers 110 that has a same or similar hardware configuration (e.g., CPU, memory, network bandwidth etc.) as the first processing server 124e and/or hosts and runs same or similar workload as the first processing server 124e. The term “workload” refers to one or more software applications 140 processed by the first processing server 124e.

Each anomaly pattern 602 is further associated with an indicator set 606 that includes a set of one or more historical performance indicators 170f that were recorded in a pre-selected time period 612 leading up to the detection of the respective performance anomaly 604 previously detected in relation to a particular data center equipment 120 deployed at any one of the data centers 110. For example, one or more of the anomaly patterns 602 are associated with respective indicator sets 606, each of which include a set of one or more historical performance indicators 170f that were recorded in the pre-selected time period 612 leading up to the detection of the respective performance anomaly 604 previously detected in relation to the first processing server 124e or a similar processing server 124d deployed at any one of the data centers 110. Essentially, the indicator set 606 associated with an anomaly pattern 602 represents a pattern of historical performance indicators 170f associated with a respective previously detected historical performance anomaly 604. Thus, each anomaly pattern 602 is associated with a particular historical performance anomaly 604 previously detected in relation to the first processing server 124e (or a similar processing server 124) and an indicator set 606 that represents a pattern of historical performance indicators 170f indicating/uniquely identifying the particular historical performance anomaly 204.

As described above, a performance indicator 170 may include an informational message 172, an error message 174, a record value of a performance metric 176, or a combination thereof. Thus, an example indicator set 606 may include a combination of one or more informational messages 172, one or more error messages 174, one or more values of performance metrics 176 (e.g., historical performance metrics 176f), or a combination thereof generated/recorded in relation to the first processing server 124e (or similar processing server 124) in the pre-selected time period 612 leading up to detection of a historical performance anomaly 604. For example, an indicator set 606 of an anomaly pattern 602 associated with a previously detected failure of the first processing server 124e or a similar processing server 124 may include specific recorded values of CPU response times, CPU usage, memory usage associated with the respective first processing server 124e or the similar processing server 124. For example, the recorded values may include low CPU response times, high CPU usage and high memory usage that caused the first processing server 124e to fail.

It may be noted two separate events of the same performance anomalies (e.g., historical performance anomalies 604, detected performance anomalies 630) may be caused by a different reason. For example, a first server failure may be caused by a malfunctioning CPU and a second server failure may be caused by memory failure. Thus, the respective indicator sets 606 associated with two different instances of the same historical performance anomaly 604 (e.g., server failure) may be different. Following the above example, a first indicator set 606 of a first anomaly pattern 602 associated with the first server failure caused by malfunctioning CPU may include recorded values of CPU response times and CPU usage. On the other hand, a second indicator set 606 a second anomaly pattern 602 associated with the second server failure caused by the malfunctioning memory may include recorded values of memory usage.

In one or more embodiments, each anomaly pattern 602 for a respective historical performance anomaly 604 is further associated with a respective remediation process 608 that was implemented to resolve the respective historical performance anomaly 604 associated with the anomaly pattern 602. The controller 150 may be configured to additionally train the AI model 160d based on remediation processes 608 associated with respective anomaly patterns 602, to determine a remediation process 608 that can be implemented to resolve a detected performance anomaly 630 in relation to the first processing server 124e. A remediation process 608 associated with a respective anomaly pattern 602 is a remediation process 608 that was implemented to resolve a respective historical performance anomaly 604 associated with the anomaly pattern 602. As shown in FIG. 6, the training data 164 used to train the AI model 160d includes remediation processes 608 associated with the respective anomaly patterns 602.

Once the AI model 160d is trained, the controller 150 may be configured to execute the ML algorithm 162d of the AI model 160d to identify an anomaly pattern 602 in real-time performance indicators 170e (associated with a detected performance anomaly 630) fed as input data 166 to the AI model 160d and determine a remediation process 608 that can resolve the detected performance anomaly 630. For example, the controller 150 may be configured to monitor data center equipment 120 (e.g., first processing server 124e) deployed in data center 110 for detected performance anomalies 630. Additionally, the controller 150 may have access to real-time performance indicators 170e generated/recorded in relation to various data center equipment 120 deployed in the data center 110. Once a detected performance anomaly 630 is detected in relation to a particular data center equipment 120 (e.g., first processing server 124e), the controller 150 may be configured to access real-time performance indicators 170e generated/recorded in relation to the particular data center equipment 120 (e.g., the first processing server 124e) and input (e.g., as part of input data 166) the real-time performance indicators 170e along with information relating to the detected performance anomaly 630 to the AI model 160d. For example, once the controller 150 detects that a server failure has occurred at the first processing server 124e, the controller accesses real-time performance indicators 170e generated/recorded in relation to the first processing server 124e and inputs the real-time performance indicators 170e and an indication of the server failure to the AI model 160d.

Real-time performance indicators 170e fed as input data 166 to the AI model 160d may include performance indicators 170 that are generated/recorded in a pre-selected time period 612 before the respective detected performance anomaly 630 is detected. For example, the real-time performance indicators 170e fed as input data 166 to the AI model 160d may include real-time performance indicators 170e (including recorded values of real-time performance metrics 176a) that are generated/recorded in the pre-selected time period 612 leading up to the detection of a respective detected performance anomaly 630 at the first processing server 124e.

Execution of the ML algorithm 162d associated with the AI model 160d causes the AI model 160d to first select one or more anomaly patterns 602 that are associated with processing servers 124 (e.g., deployed across various data centers 110) that are same or similar to the first processing server 124e and are further associated with historical performance anomalies 604 that are same or similar to the detected performance anomaly 630 in relation to the first processing server 124e. In other words, the AI model 160d selects those anomaly patterns 602 associated with historical performance anomalies 604 that are same or similar to the detected performance anomaly 630, wherein the historical performance anomalies 604 were previously detected in relation to respective processing servers 124 that are same or similar to the first processing server 124e. For example, when a server failure is detected at the first processing server 124e, the AI model 160d selects anomaly patterns 602 associated with server failures previously detected at the first processing server 124e or a similar processing server 124.

The AI model 160d then compares the plurality of real-time performance indicators 170e (from the input data 166) generated/recorded in relation to the first processing server 124e to respective indicator sets 606 of the selected anomaly patterns 602. In other words, the AI model 160d compares the real-time performance indicators 170e generated/recorded in relation to the first processing server 124e to indicator sets 606 of historical performance indicators 170f that indicate/identify the same or similar detected performance anomaly 630 previously detected in relation to the first processing server 124e or other processing servers 124 that are similar to the first processing server 124e. The goal of this comparison is to determine a selected anomaly pattern 602 and associated indicator set 606 that matches or closely matches with a respective pattern of real-time performance indicators 170e. The idea here is that when the indicator set 606 associated with a particular selected anomaly pattern 602 matches with a corresponding pattern of real-time performance indicators 170e recorded for the first processing server 124e, there is a high likelihood that the same reason(s) that caused the historical performance anomaly 604 associated with the particular selected anomaly pattern 602 also caused the detected performance anomaly 630 relating to the first processing server 124e. For example, when both the detected performance anomaly 630 and the historical performance anomaly 604 relate to server failure, and particular values of CPU response time and CPU usage that are part of the indicator set 606 matches or closely matches with corresponding values of CPU response time and CPU usage in the real-time performance indicators 170e, then there is a high likelihood that both the previous server failure associated with the particular selected anomaly pattern 602 and the server failure of the first processing server 124 were caused by CPU malfunction.

Upon determining a pattern of real time performance indicators 170e that matches or closely matches with a particular indicator set 606 of historical performance indicators 170b associated with a particular selected anomaly pattern 602, the AI model 160d determines a particular remediation process 608 associated with the particular selected anomaly pattern 602 and outputs the particular remediation process 608 as part of result data 168. The idea here is that if a particular pattern of historical performance indicators 170f (e.g., indicator set 606) was detected leading up to a particular historical performance anomaly 604 previously detected in relation to a processing server 124 that is similar to the first processing server 124e, and if the same or similar pattern (indicator set 606) of real-time performance indicators 170e is later detected leading up to a detected performance anomaly 630 in relation to the first processing server 124e that is same or similar to the historical performance anomaly 604, there is a good likelihood that the reasons that caused both the historical performance anomaly 604 and detected performance anomaly 630 are similar. Thus, the remediation process 608 used to resolve the historical performance anomaly 604 may also resolve the detected performance anomaly 604 in relation to the first processing server 124e.

For example, if the server failure associated with the particular selected anomaly pattern 602 that was caused by CPU malfunction was previously resolved by migrating processing of workload to a different processing server, then the server failure of the first processing server 124e that is also caused by a CPU malfunction is likely to be resolved by migrating workload from the first processing server 124e to a second processing server (e.g., processing server 124f).

In one or more embodiments, upon obtaining the remediation process 608 as part of result data 168, the controller 150 may be configured to automatically implement the remediation process 608 to resolve the detected performance anomaly 630 in relation to the first processing server 124e.

In one or more embodiments, each anomaly pattern 602 for a respective historical performance anomaly 604 is further associated with information relating to a respective pattern architecture 610 associated with a data center 110 where the data center equipment 120 (e.g., where the historical performance anomaly 604 was detected) is deployed. For example, when a historical performance anomaly 604 was detected in relation to a processing server 124g deployed in data center 110, then the respective anomaly pattern 602 includes information relating to the pattern architecture 610 associated with the data center 110 where processing server 124g is deployed. The pattern architecture 610 associated with the data center 110 may include a hardware architecture of the data center 110 including information relating to how various data center equipment 120 are coupled to each other. Additionally, or alternatively, the pattern architecture 610 associated with the data center 110 may include a software architecture of the data center 110 including software applications hosted/deployed and/or scheduled to process at each data center equipment 120 in the data center 110. The controller 150 may be configured to additionally train the AI model 160d based on pattern architectures 610 associated with respective anomaly patterns 602.

In an additional embodiment, upon detection of the detected performance anomaly 630 in relation to the first processing server 124e, the controller 150 may be configured to determine a detected architecture 632 associated with the data center 110 where the first processing server 124e is deployed and input the detected architecture 632 to the AI model 160d as part of input data 166. The detected architecture 632 associated with the data center 110 may include a hardware architecture of the data center 110 including information relating to how various data center equipment 120 are coupled to each other. For example, the detected architecture 632 may include processing servers 124f, 124g, and 124h coupled to the first processing server 124e. Additionally, or alternatively, the detected architecture 632 associated with the data center 110 may include a software architecture of the data center 110 including software applications hosted/deployed and/or scheduled to process at each data center equipment 120 in the data center 110.

In one or more embodiments, execution of the ML algorithm 162d of the AI model 160d additionally causes the AI model 160d to determine those anomaly patterns 602 that relate to historical performance anomalies 604 previously detected in relation to respective data center equipment 120 deployed in a data center 110 that is same or similar to the data center 110 where the first processing server 124e is deployed. The AI model 160d selects the anomaly patterns 602 as described above from these determined anomaly patterns 602, and then proceeds to determine the remediation process 608 based on the selected anomaly patterns 602 as described above. Considering anomaly patterns 602 associated with only those data center equipment 120 deployed in a data center 110 that has the same or similar architecture as the data center 110 where the first processing server 124e is deployed improves the accuracy of remediation processes 608 generated by the AI model 160d.

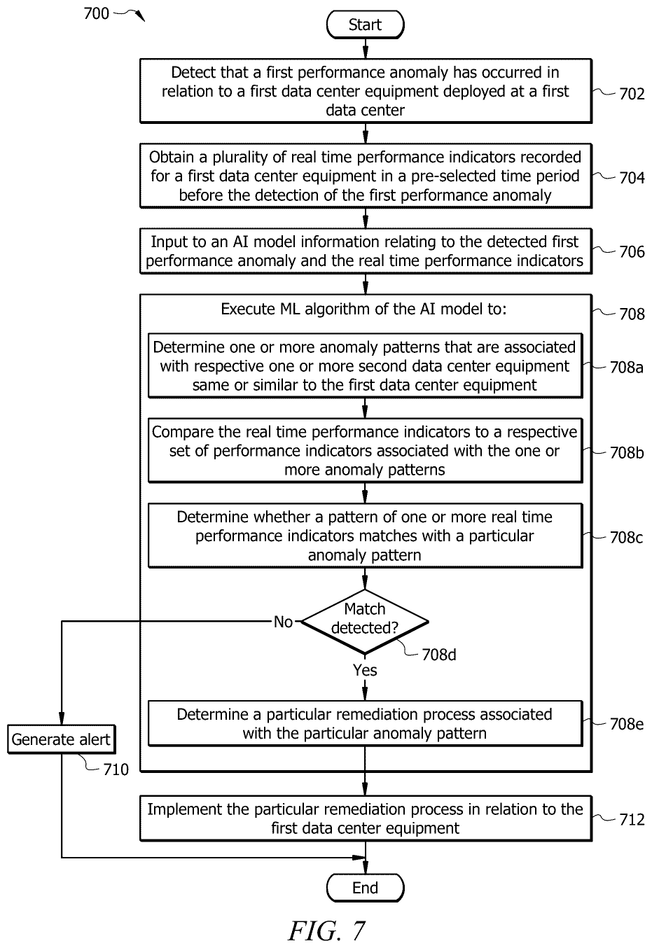

FIG. 7 illustrates a flowchart of an example method 700 for determining a remediation process associated with a performance anomaly detected in relation to a data center equipment 120 deployed in a data center 110, in accordance with one or more embodiments of the present disclosure. Method 700 may be performed by the controller 150 as shown in FIGS. 1 and 6. Method 700 is described herein with reference to FIG. 6.

At operation 702, controller 150 detects that a first performance anomaly (e.g., detected performance anomaly 630) has occurred in relation to a first data center equipment (e.g., first processing server 124e) deployed at a first data center 110.

As described above, the controller 150 may be configured to monitor data center equipment 120 (e.g., first processing server 124e) deployed in data center 110 for detected performance anomalies 630.

At operation 704, controller 150 obtains a plurality of real time performance indicators 170e recorded in a pre-selected time period 612 before the detection of the first performance anomaly (e.g., detected performance anomaly 630) and that indicate real time performance of the first data center equipment (e.g., first processing server 124e) in the pre-selected time period 612.

As described above, the controller 150 may have access to real-time performance indicators 170e generated/recorded in relation to various data center equipment 120 deployed in the data center 110. Once a detected performance anomaly 630 is detected in relation to a particular data center equipment 120 (e.g., first processing server 124e), the controller 150 may be configured to access real-time performance indicators 170e generated/recorded in relation to the particular data center equipment 120 (e.g., the first processing server 124e) and input (e.g., as part of input data 166) the real-time performance indicators 170e along with information relating to the detected performance anomaly 630 to the AI model 160d. For example, once the controller 150 detects that a server failure has occurred at the first processing server 124e, the controller accesses real-time performance indicators 170e generated/recorded in relation to the first processing server 124e and inputs the real-time performance indicators 170e and an indication of the server failure to the AI model 160d.

Real-time performance indicators 170e fed as input data 166 to the AI model 160d may include performance indicators 170 that are generated/recorded in a pre-selected time period 612 before the respective detected performance anomaly 630 is detected. For example, the real-time performance indicators 170e fed as input data 166 to the AI model 160d may include real-time performance indicators 170e (including recorded values of real-time performance metrics 176a) that are generated/recorded in the pre-selected time period 612 leading up to the detection of a respective detected performance anomaly 630 at the first processing server 124e.

At operation 706, controller 150 inputs to the AI model 160d information relating to the detected first performance anomaly (e.g., detected performance anomaly 630) and the plurality of real time performance indicators 170e associated with the first data center equipment (e.g., first processing server 124e). The AI model 160d is trained, based on a plurality of anomaly patterns 602 associated with a plurality of data center equipment 120 (e.g., processing servers 124) deployed at a plurality of data centers 110 (e.g., 110a, 110b, . . . 110n shown in FIG. 1) and respective remediation processes 608 associated with the anomaly patterns 602, to determine one of the remediation processes 608 that can be implemented to resolve the detected first performance anomaly (e.g., detected performance anomaly 630) associated with the first data center equipment (e.g., first processing server 124e). Each anomaly pattern 602 is associated with a previously detected performance anomaly (e.g., historical performance anomaly 604) at a particular data center equipment 120 (e.g., processing server 124) deployed at a particular data center 110 of the plurality of data centers 110 (e.g., 110a, 110b, . . . 110n shown in FIG. 1). Each anomaly pattern 602 comprises a set of performance indicators (e.g., indicator set 606) recorded in the pre-selected time period 612 leading up to a respective performance anomaly (e.g., historical performance anomaly 604) previously detected in relation to a particular data center equipment 120 (e.g., processing server 124) deployed at a particular data center 110. Further, each remediation process 608 associated with a respective anomaly pattern 602 was implemented to resolve a respective previously detected performance anomaly (e.g., historical performance anomaly 604) associated with the respective anomaly pattern 602.

As described above, the AI model 160d is configured/trained to determine one or more remediation processes 608 to resolve detected performance anomalies 630 that occur in the data center 110 and further to automatically resolve the detected performance anomalies 630 by implementing the one or more remediation processes 608. As described above, a performance anomaly in a data center 110 generally refers to a significant deviation from the expected, normal operating behavior of a data center equipment 120 such as a processing server 124, network equipment 126, or other system within the data center 110, often manifesting as a sudden spike or drop in performance metrics like CPU response, CPU usage, memory utilization, network throughput, disk I/O, or application response times indicating a potential issue that needs investigation and troubleshooting. In one or more embodiments, the controller 150 may be configured to monitor a plurality of data center equipment 120 deployed in the data center 110 and detect when a particular piece of data center equipment 120 has experienced a performance anomaly. For example, the controller 150 may be configured to detect when the first processing server 124e experiences a performance anomaly. The performance anomaly detected in relation to a data center equipment 120 (e.g., first processing server 124e) is herein referred to as detected performance anomaly 630.

In one example, the AI model 160d may be trained to determine a remediation process 608 to resolve a detected performance anomaly 630 in relation to the first processing server 124e deployed in the data center 110. In one embodiment, the controller 150 may be configured to train the AI model 160d based on a plurality of anomaly patterns 602 associated with a plurality of data center equipment 120 deployed across a plurality of data centers 110 (e.g., data centers 110a, 110b, . . . 110n as shown in FIG. 1). These anomaly patterns 602 may include anomaly patterns 602 associated with the first processing server 124e or similar processing servers 124 deployed across the plurality of data centers 110. As shown in FIG. 4, the training data 164 used to train the AI model 160d includes the anomaly patterns 602. Each anomaly pattern 602 is associated with a particular historical performance anomaly 604 that was previously detected in relation to a particular data center equipment 120 deployed at a particular data center 110. For example, one or more anomaly patterns 602 are associated with historical performance anomalies 604 that were previously detected in relation to the first processing server 124e or other processing servers 124 across multiple data centers 110 that are similar to the first processing server 124e. A processing server 124 that is similar to the first processing server 124e may include any processing server 124 deployed at any one of the plurality of data centers 110 that has a same or similar hardware configuration (e.g., CPU, memory, network bandwidth etc.) as the first processing server 124e and/or hosts and runs same or similar workload as the first processing server 124e. The term “workload” refers to one or more software applications 140 processed by the first processing server 124e.

Each anomaly pattern 602 is further associated with an indicator set 606 that includes a set of one or more historical performance indicators 170f that were recorded in a pre-selected time period 612 leading up to the detection of the respective performance anomaly 604 previously detected in relation to a particular data center equipment 120 deployed at any one of the data centers 110. For example, one or more of the anomaly patterns 602 are associated with respective indicator sets 606, each of which include a set of one or more historical performance indicators 170f that were recorded in the pre-selected time period 612 leading up to the detection of the respective performance anomaly 604 previously detected in relation to the first processing server 124e or a similar processing server 124d deployed at any one of the data centers 110. Essentially, the indicator set 606 associated with an anomaly pattern 602 represents a pattern of historical performance indicators 170f associated with a respective previously detected historical performance anomaly 604. Thus, each anomaly pattern 602 is associated with a particular historical performance anomaly 604 previously detected in relation to the first processing server 124e (or a similar processing server 124) and an indicator set 606 that represents a pattern of historical performance indicators 170f indicating/uniquely identifying the particular historical performance anomaly 204.

As described above, a performance indicator 170 may include an informational message 172, an error message 174, a record value of a performance metric 176, or a combination thereof. Thus, an example indicator set 606 may include a combination of one or more informational messages 172, one or more error messages 174, one or more values of performance metrics 176 (e.g., historical performance metrics 176f), or a combination thereof generated/recorded in relation to the first processing server 124e (or similar processing server 124) in the pre-selected time period 612 leading up to detection of a historical performance anomaly 604. For example, an indicator set 606 of an anomaly pattern 602 associated with a previously detected failure of the first processing server 124e or a similar processing server 124 may include specific recorded values of CPU response times, CPU usage, memory usage associated with the respective first processing server 124e or the similar processing server 124. For example, the recorded values may include low CPU response times, high CPU usage and high memory usage that caused the first processing server 124e to fail.

It may be noted two separate events of the same performance anomalies (e.g., historical performance anomalies 604, detected performance anomalies 630) may be caused by a different reason. For example, a first server failure may be caused by a malfunctioning CPU and a second server failure may be caused by memory failure. Thus, the respective indicator sets 606 associated with two different instances of the same historical performance anomaly 604 (e.g., server failure) may be different. Following the above example, a first indicator set 606 of a first anomaly pattern 602 associated with the first server failure caused by malfunctioning CPU may include recorded values of CPU response times and CPU usage. On the other hand, a second indicator set 606 a second anomaly pattern 602 associated with the second server failure caused by the malfunctioning memory may include recorded values of memory usage.

In one or more embodiments, each anomaly pattern 602 for a respective historical performance anomaly 604 is further associated with a respective remediation process 608 that was implemented to resolve the respective historical performance anomaly 604 associated with the anomaly pattern 602. The controller 150 may be configured to additionally train the AI model 160d based on remediation processes 608 associated with respective anomaly patterns 602, to determine a remediation process 608 that can be implemented to resolve a detected performance anomaly 630 in relation to the first processing server 124e. A remediation process 608 associated with a respective anomaly pattern 602 is a remediation process 608 that was implemented to resolve a respective historical performance anomaly 604 associated with the anomaly pattern 602. As shown in FIG. 6, the training data 164 used to train the AI model 160d includes remediation processes 608 associated with the respective anomaly patterns 602.

At operation 708, controller 150 executes a machine-learning algorithm 162d associated with the AI model 160d to perform a plurality of operations including operations 708A, 708B, 708C, 708D, and 708F to determine a remediation process 608 that can be implemented to resolve the first performance anomaly (e.g., detected performance anomaly 630) detected in relation to the first data center equipment 120 (e.g., first processing server 124e).

As described above, once the AI model 160d is trained, the controller 150 may be configured to execute the ML algorithm 162d of the AI model 160d to identify an anomaly pattern 602 in real-time performance indicators 170e (associated with a detected performance anomaly 630) fed as input data 166 to the AI model 160d and determine a remediation process 608 that can resolve the detected performance anomaly 630.

At operation 708A, AI model 160D determines one or more anomaly patterns 602 of the plurality of anomaly patterns 602 that are associated with respective one or more second data center equipment 120 (e.g., processing servers 124) that are same or similar to the first data center equipment 120 (e.g., first processing server 124e) and are associated with respective previously detected performance anomalies (e.g., historical performance anomalies 604) that are same or similar to the detected first performance anomaly (e.g., detected performance anomaly 630).

As described above, execution of the ML algorithm 162d associated with the AI model 160d causes the AI model 160d to first select one or more anomaly patterns 602 that are associated with processing servers 124 (e.g., deployed across various data centers 110) that are same or similar to the first processing server 124e and are further associated with historical performance anomalies 604 that are same or similar to the detected performance anomaly 630 in relation to the first processing server 124e. In other words, the AI model 160d selects those anomaly patterns 602 associated with historical performance anomalies 604 that are same or similar to the detected performance anomaly 630, wherein the historical performance anomalies 604 were previously detected in relation to respective processing servers 124 that are same or similar to the first processing server 124e. For example, when a server failure is detected at the first processing server 124e, the AI model 160d selects anomaly patterns 602 associated with server failures previously detected at the first processing server 124e or a similar processing server 124.

At operation 708B, AI model 160D compares the plurality of real time performance indicators 170e recorded for the first data center equipment 120 (e.g., first processing server 124e) to a respective set of performance indicators (e.g., indicator set 606) associated with the one or more anomaly patterns 602.

At operation 708C, AI model 160D determines whether a pattern of one or more real time performance indicators 170e matches or closely matches with a particular set of performance indicators (e.g., indicator set 606) associated with a particular anomaly pattern 602 of the one or more anomaly patterns 602.

As described above, AI model 160d compares the plurality of real-time performance indicators 170e (from the input data 166) generated/recorded in relation to the first processing server 124e to respective indicator sets 606 of the selected anomaly patterns 602. In other words, the AI model 160d compares the real-time performance indicators 170e generated/recorded in relation to the first processing server 124e to indicator sets 606 of historical performance indicators 170f that indicate/identify the same or similar detected performance anomaly 630 previously detected in relation to the first processing server 124e or other processing servers 124 that are similar to the first processing server 124e. The goal of this comparison is to determine a selected anomaly pattern 602 and associated indicator set 606 that matches or closely matches with a respective pattern of real-time performance indicators 170e.

At operation 708D, if no patterns of one or more real time performance indicators 170e matches or closely matches with a particular set of performance indicators (e.g., indicator set 606) associated with a particular anomaly pattern 602 of the one or more anomaly patterns 602, method 700 proceeds to operation 710 where the controller, based on the AI model's determination, generates an alert message to cause a data center technician to investigate and resolve the first performance anomaly (e.g., detected performance anomaly 630) detected in relation to the first data center equipment 120 (e.g., first processing server).

On the other hand, if a pattern of one or more real time performance indicators 170e matches or closely matches with a particular set of performance indicators (e.g., indicator set 606) associated with a particular anomaly pattern 602 of the one or more anomaly patterns 602, method 700 proceeds to operation 708E where the AI model 160d determines a particular remediation process 608 associated with the particular anomaly pattern 602.

As described above, upon determining a pattern of real-time performance indicators 170e that matches or closely matches with a particular indicator set 606 of historical performance indicators 170b associated with a particular selected anomaly pattern 602, the AI model 160d determines a particular remediation process 608 associated with the particular selected anomaly pattern 602 and outputs the particular remediation process 608 as part of result data 168. The idea here is that if a particular pattern of historical performance indicators 170f (e.g., indicator set 606) was detected leading up to a particular historical performance anomaly 604 previously detected in relation to a processing server 124 that is similar to the first processing server 124e, and if the same or similar pattern (indicator set 606) of real-time performance indicators 170e is later detected leading up to a detected performance anomaly 630 in relation to the first processing server 124e that is same or similar to the historical performance anomaly 604, there is a good likelihood that the reasons that caused both the historical performance anomaly 604 and detected performance anomaly 630 are similar. Thus, the remediation process 608 used to resolve the historical performance anomaly 604 may also resolve the detected performance anomaly 604 in relation to the first processing server 124e.

For example, if the server failure associated with the particular selected anomaly pattern 602 that was caused by CPU malfunction was previously resolved by migrating processing of workload to a different processing server, then the server failure of the first processing server 124e that is also caused by a CPU malfunction is likely to be resolved by migrating workload from the first processing server 124e to a second processing server (e.g., processing server 124f).

At operation 712, controller 150 implements the particular remediation process 608 in relation to the first data center equipment 120 (e.g., first processing server 124e) to resolve the detected first performance anomaly (e.g., detected performance anomaly 630) associated with the first data center equipment 120 (e.g., first processing server 124e).

As described above, upon obtaining the remediation process 608 as part of result data 168, the controller 150 may be configured to automatically implement the remediation process 608 to resolve the detected performance anomaly 630 in relation to the first processing server 124e.

### Optimizing Power Consumption in a Data Center

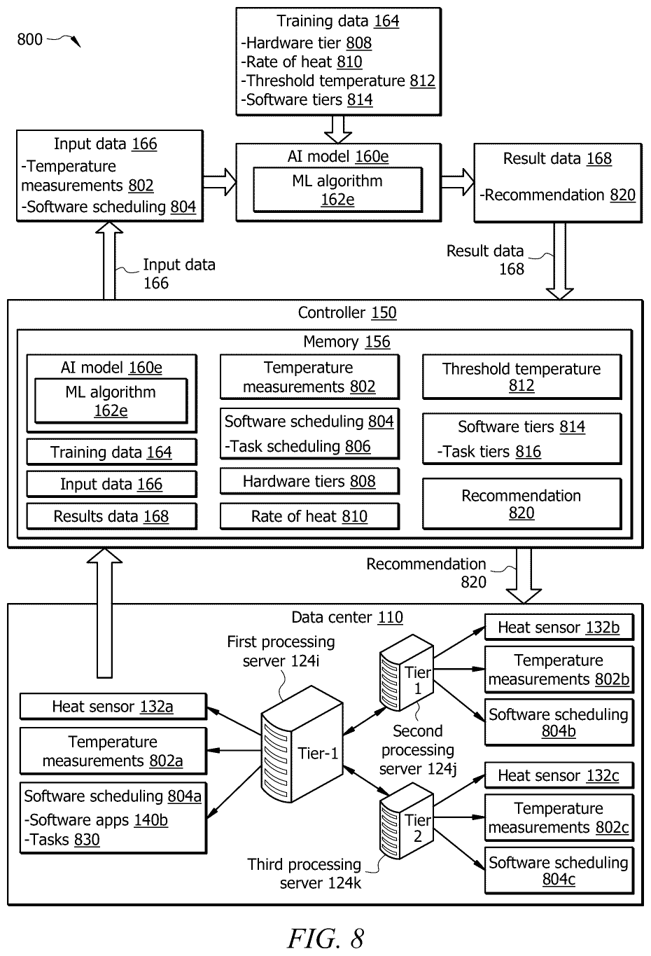

Generally, processing servers 124 associated with a higher processing performance consume higher electrical power as compared to processing servers 124 associated with lower processing performance. For example, tier-1 processing servers 124i and 124j (shown in FIG. 8) consume higher electrical power compared to tier-2 processing server 124k (shown in FIG. 8). Higher-performance processors tend to consume more power due to several factors related to their architecture, design, and the demands placed on them during operation. One major factor contributing to higher power consumption related to higher performing processing servers 124 is the power consumed in cooling down these processing servers 124 and components therein (e.g., processors). Processing servers 124 in data centers 110 require cooling because they generate significant amounts of heat while operating, and excess heat can negatively affect performance, reliability, and longevity of both the servers and other critical components like storage systems, networking equipment, and power supplies. As higher performance processors perform more work and run at higher speeds, they generate more heat causing more electrical power to be consumed by HVAC solutions 130 (shown in FIG. 1) to cool the increased thermal output.

Other factors that cause higher performance servers to consume more power include, faster clock speeds, higher core count, higher processor count, higher cache size, or a combination thereof. For example, faster clock speeds associated with a faster processor means that the circuits switch more frequently (higher frequency), which increases dynamic power consumption. In another example, a processor with more cores or more transistors in its design consumes more power, as each additional unit adds to the overall energy requirement. In another example, larger caches and more complex designs (like multiple levels of cache or specialized units like AI accelerators) requires more power. The complexity of the design itself, combined with the need to quickly access large amounts of data, increases the power draw.

Higher performance servers (e.g., processing servers 124) tend to consume higher electrical power even when these servers are processing relatively lighter workloads. For example, a higher-performance server (e.g., tier-1 server) generally consumes more power and generates more heat than a lower-performance server (e.g., tier-2 server) when processing the same workload. This is due to factors like higher clock speeds, more cores, and greater computational capabilities associated with processors employed by the higher-performance servers. While a higher-performance processor of a higher-performance server and a lower-performance processor of a lower-performance server may complete the same task, the higher-performance processor is usually designed to handle much more demanding workloads, which leads to greater power consumption and heat generation. Even for lighter tasks, the higher-performance processor tends to use more resources, such as running at higher clock speeds or using more cores, which leads to increased power draw and heat output. Thus, even if both processors are running the same task (e.g., a simple web browser or word processor), the higher-performance processor will still consume more power and generate more heat because of its more powerful design. For example, even when processing the same tier-2 task 830, a tier-1 processing server 124 (e.g., first processing server 124i as shown in FIG. 8) consumes generates more heat and consumes higher power than a tier-2 processing server 124 (e.g., third processing server 124k as shown in FIG. 8).

In conventional data centers 110, software applications 140 or associated tasks needing lower tier processing are often processed by higher tier servers due to several factors including, but not limited to, lack of visibility relating to resource availability across the data center 110, lack of visibility relating to processing needs of software applications 140 or tasks thereof, excess capacity, and lack of proper resource management and workload distribution. This often causes unnecessary higher power consumption and generation of excessive heat by higher-performance processing servers 124 (e.g., first processing server 124i) when the same tasks can be processed by lower-performance processing servers 124 (e.g., third processing server 124k) causing relatively lower power consumption and lower heat generation. The higher heat generation causes more electrical power to be consumed by HVAC solutions 130 (shown in FIG. 1) to cool the increased thermal output of the higher-performance processing servers 124. Additionally, higher heat often lowers performance of the processors employed by the processing servers 124 due to thermal throttling, component degradation, and thermal limits that are designed to protect the processor and maintain stable operation.

Embodiments of the present disclosure overcome the limitations described above by providing improved techniques for reducing power consumption in a data center 110. As described in embodiments of the present disclosure, the disclosed techniques include reducing power consumption related to cooling down data center equipment by proactively detecting data center equipment 120 that can generate excessive heat and, in response, migrating at least a portion of the workload to another data center equipment 120 to avoid the excessive heat generation. The disclosed techniques also include techniques to detect a software application 140 or a software task needing a lower software tier being processed by a processing server 124 assigned a higher equivalent hardware tier and, in response, migrating the software application 140 or tasks to another available processing server 124 that is assigned a lower hardware tier, thus saving power.

FIG. 8 illustrates an example operational diagram 800 for reducing power consumption in a data center 110, in accordance with one or more embodiments of the present disclosure. It may be noted that that the same components are identified using the same reference numerals across figures referenced in this disclosure.

As shown in FIG. 8, the AI models 160 stored by the controller 150 may include AI model 160e and respective ML algorithm 162e. The controller 150 may further store temperature measurements 802 of data center equipment 120 (e.g., processing servers 124i, 124, j, 124k), software scheduling 804 at each data center equipment 120 (e.g., processing servers 124i, 124, j, 124k), hardware tiers 808 associated with data center equipment 120 (e.g., processing servers 124i, 124, j, 124k), rate of heat 810 associated with each hardware tier 808, threshold temperature 812, software tiers 814 associated with software applications 140 (e.g., software application 140b) scheduled for processing in the data center 110, and recommendations 820 generated by the AI model 160e as part of results data 168.

In one or more embodiments, each processing server 124 (e.g., processing servers 124i, 124, j, 124k) deployed in the data center 110 is assigned a particular hardware tier 808, wherein the hardware tier 808 is a performance tier and represents a degree of processing performance associated with a respective processing server 124. For example, a higher hardware tier 808 assigned to a processing server 124 means that the processing server 124 has a higher processing performance as compared to another processing server 124 that is associated with a lower hardware tier 808. Higher processing performance generally means that a processing server 124 can process a larger amount of data and instructions as compared to another processing sever 124 that has lower performance. Several factors can dictate the processing performance of a processing server 124 including, but not limited to, clock speed, core count, processor count, and cache size. In one example, a processing server 124 associated with a higher hardware tier 808 may have a processor with a higher clock speed (measured in gigahertz, GHz), meaning the processor can process more instructions per second. For example, a 3.5 GHz processor can perform more operations in the same amount of time than a 2.0 GHz processor. In another example, a processing server 124 associated with a higher hardware tier 808 may include a processor with a higher core count, meaning the processor has more cores or threads which can handle multiple tasks at once. For example, an 8-core processor can run multiple applications simultaneously without significant slowdowns. In another example, a processing server 124 associated with a higher hardware tier 808 may include a larger cache size for storing frequently used data closer to the processor. This reduces the time spent retrieving data from slower RAM. In another example, a processing server 124 associated with a higher hardware tier 808 may include multiple processors allowing the processing server to process multiple tasks simultaneously. For example, as shown in FIG. 8, the first processing server 124i is assigned a hardware tier 808 of tier-1, the second processing server 124j is assigned a hardware tier 808 of tier-1, and the third processing server 124k is assigned a hardware tier 808 of tier-3. In the context of the present disclosure, tier-1 is a higher hardware tier 808 as compared to tier-2, meaning that processing servers 124 assigned tier-1 have a higher processing performance as compared to processing servers 124 assigned tier-2.

In one or more embodiments, each software application 140 scheduled to be processed by a processing server 124 of the data center 110 is assigned a software tier 814, wherein a software tier 814 assigned to a software application 140 indicates a hardware tier 808 needed to process at least a portion of the software application 140. For example, a software tier 814 of tier-2 indicates that the respective software application 140 needs to be processed by a processing server 124 that is at least assigned a hardware tier 808 of tier-2. In one embodiment, a software application 140 assigned a particular software tier 814 can only be processed by a processing server 124 that is assigned an equivalent or higher hardware tier 808. In other words, a software application 140 needing certain processing capabilities can only be processed by processing servers 124 having the requested or higher processing capabilities. For example, a software application 140 assigned tier-2 can be processed by tier-2 or tier-1 processing servers 124. However, a software application 140 assigned tier-1 cannot be processed by a tier-2 processing server. Generally processing of a software application 140 includes processing of a plurality of tasks 830. Different tasks 830 associated with the software application 140 may need different levels of processing performance of the processing server 124. For example, a first task 830 may need tier-1 processing performance, while a second task 830 may only need tier-2 processing performance. In one embodiment, a software application 140 may be assigned one or more task tiers 816 that indicate corresponding hardware tiers 808 needed to process the respective one or more tasks 830. For example, tasks 1, 2 and 5 of a software application 140 may be assigned tier-1, while tasks 3, 4, and 6 may be assigned tier-2. Each task 830 having an assigned task tier 816 can be processed by processing servers 124 having an equivalent or higher hardware tier 808.

In one or more embodiments, the AI model 160e is configured/trained to optimize power consumption in a data center 110 by generating recommendations 820 to migrate software applications 140 or portions thereof (e.g., one or more tasks 830) among the processing servers 124 deployed in the data center 110. For example, optimizing power consumption in the data center 110 may include reducing power consumption associated with cooling the processing servers 124 by recommending migration of one or more software applications 140 or portions thereof (e.g., one or more tasks 830) among the processing servers 124 to distribute heat among the processing servers 124. Additionally, or alternatively, optimizing power consumption in the data center 110 may include reducing power consumption by processing servers 124 by migrating one or more software applications 140 or portions thereof (e.g., one or more tasks 830) from a higher-performance (e.g., tier-1) processing server (e.g., first processing server 124i to a lower-performance (e.g., tier-2) processing server (e.g., third processing server 124k).

In one or more embodiments, the controller 150 may be configured to train the AI model 160e based on training data 164 to generate the recommendations 820 for migrating software applications 140/tasks 830 among processing servers 124. As shown in FIG. 8, the training data 164 used to train the AI model 160e includes one or more of hardware tiers 808 assigned to each processing server 124 (e.g., processing servers 124i, 124j, 124k), software tiers 814 assigned to each software application 140 scheduled for processing in the data center 110, a rate of heat 810 associated with each hardware tier 808, or a threshold temperature 812 associated with each processing server 124. The rate of heat 810 associated with a particular hardware tier 808 indicates an estimated amount of heat generated per unit time (e.g., per second, per minute etc.) of processing by a processing server 124 of the particular hardware tier 808. The estimated heat generated per unit time may include an average heat generated per unit time, a minimum heat generated per unit time, or a maximum heat generated per unit time. A threshold temperature 812 associated with a particular processing server 124 includes a maximum measured heat (e.g., measured in ° C./° F.) that is not to be exceeded for the processing server 124.

Once the AI model 160e is trained, the controller 150 may be configured to execute the ML algorithm 162e to generate a recommendation 820 based on input data 166 fed to the AI model 160e. As shown in FIG. 8, the input data 166 fed to the AI model 160e includes temperature measurements 802 relating to each of a plurality of processing servers 124 (e.g., first processing server 124i, second processing server 124g, third processing server 124k), software scheduling 804 relating to software application(s) scheduled for processing at each of the plurality of processing servers 124, or a combination thereof. In one embodiment, the hardware sensors 132 (shown in FIG. 1) deployed in the data center 110 include heat sensors 132 (shown as 132a, 132b, and 132c) that are configured to measure temperature at each of the processing servers 124 (e.g., first processing server 124i, second processing server 124g, third processing server 124k). As shown in FIG. 8, heat sensor 132a is configured to generate/record temperature measurements 802a including measured temperature readings of the first processing server 124i. Heat sensor 132b is configured to generate/record temperature measurements 802b including measured temperature readings of the second processing server 124j. Heat sensor 132c is configured to generate/record temperature measurements 802c including measured temperature readings of the third processing server 124k. In one embodiment, a heat sensor 132 may be configured to generate/record a temperature measurement 802 periodically or according to a pre-configured schedule. In one embodiment, controller 150 receives measurement signals from each of the heat sensors 132 (e.g., 132a, 132b, and 132c) and stores the corresponding temperature measurements 802 included or indicated by the measurement signals.

The software scheduling 804 associated with a particular processing server 124 may include information relating to one or more software applications 140 scheduled for processing at the particular processing server 124. Additionally, the software scheduling 804 may include tasks scheduling 806 with information relating to one or more tasks 830 relating to each of the one or more software applications 140 scheduled for processing at the particular processing server 124. For example, as shown in FIG. 8, software scheduling 804a relating to the first processing server 124i includes an indication that the software application 140b is scheduled to process at the first processing server 124i. Software scheduling 804a additionally includes tasks scheduling 806 with information relating to one or more tasks 830 relating to the software application 140b that are scheduled for processing by the first processing server 124i. The software scheduling 894 may additionally include information relating to when each of the software applications 140 and each of the tasks 830 are scheduled to process at the respective processing servers 124. For example, software scheduling 804a includes information relating to when (e.g., time of day) the software application 140b and each task 830 is scheduled for processing at the first processing server 124i.

Once input data 166 is fed to the AI model 160e, execution of the ML algorithm 162e causes the AI model 160e to generate a recommendation 820 for migrating at least a portion of a software application 140 or one or more tasks 830 associated with a software application 140 that are scheduled for processing at one processing server 124 to another processing server 124 to save power. For example, based on the information relating to the software scheduling 804a (fed as part of input data 166) associated with the first processing server 124i, the AI model 160e determines that the software application 140b is scheduled for processing by the first processing server 124i. In one example use case, the AI model 160e may identify that the hardware tier 808 assigned to the first processing server 124i is tier-1 and that the software tier 814 assigned to the software application 140b is tier-2. In response, the AI model 160e may identify another processing server 124 that is assigned a hardware tier 808 of tier-2 to match the equivalent software tier 814 of the software application 140b and is available to take on processing of the software application 140b. For example, the AI model 160e may identify that the third processing server 124k is assigned a hardware tier 808 of tier 2. Further, based on the software scheduling 804c associated with the third processing server 124k, the AI model 160e determines that the third processing server 124k is available to process the software application 140b. In response to this determination, the AI model 160e generates a recommendation 820 to migrate the processing of the software application 140b from the first processing server 124i to the third processing server 124k. In response to obtaining the recommendation 820 as part of the results data 168, the controller 150 migrates processing of the software application 140b from the first processing server 124i to the third processing server 124k. Since the hardware tier 808 associated with the third processing server 124k is lower than that of the first processing server 124i, the third processing server 124k consumes less power to processing the software application 140b, thus saving power. Further, since a lower tier third processing server 124k is used to process the software application 140b, lesser heat is generated by the third processing server 124k as compared to the heat output by the first processing server 124i for processing the same software application 140b. Lesser heat generation results in lower overall power used to cool down the data center 110.

In a second use case, based on the information relating to the software scheduling 804a (fed as part of input data 166) associated with the first processing server 124i, the AI model 160e determines a particular task 830 relating to the software application 140b that is scheduled for processing by the first processing server 124i has a task tier 816 of tier 2. However, as described above, the AI model 160e identifies that the hardware tier 808 assigned to the first processing server 124i is tier 1. In response, the AI model 160e may identify that the third processing server 124k is assigned a hardware tier 808 of tier 2. Further, based on the software scheduling 804c associated with the third processing server 124k, the AI model 160e determines that the third processing server 124k is available to process the particular task 830 associated with the software application 140b. In response to this determination, the AI model 160e generates a recommendation 820 to migrate the processing of the particular task 830 from the first processing server 124i to the third processing server 124k. In response to obtaining the recommendation 820 as part of the results data 168, the controller 150 migrates processing of the particular task 830 from the first processing server 124i to the third processing server 124k. Since the hardware tier 808 associated with the third processing server 124k is lower than that of the first processing server 124i, the third processing server 124k consumes less power to processing the particular task 830, thus saving power. Additional power savings results from lower thermal output when processing the particular task by the lower tier third processing server 124k. In one embodiment, the controller 150 may be configured to migrate back the processing of the software application 140b (e.g., remaining tasks 830) to the first processing server 124i after the particular task 830 has been processed by the third processing server 124k.

In a third use case, after determining that the software application 140b is scheduled for processing by the first processing server 124i, the AI model 160e predicts whether the scheduled processing of the software application 140b by the first processing server 124i is to cause the temperature of the first processing server 124i to equal or exceed the threshold temperature 812 configured for the first processing server 124i. For example, based on the temperature measurements 802a (fed as part of input data 166) associated with the first processing server 124i, the AI model 160e may determine the most recent temperature measurement 802a at the first processing server 124i recorded by the heat sensor 132a. Further, the AI model 160e may identify that the hardware tier 808 assigned to the first processing server 124i is tier-1, and based on the rate of heat 810 value associated with tier-1 processing servers 124, the AI model 160e may estimate heat to be generated by the first processing server 124i for processing the software application 140b. Then, based on the most recent temperature measurement 802a of the first processing server 124i and the estimated heat to be generated by the first processing server 124i, the AI model 160e predicts whether the scheduled processing of the software application 140b by the first processing server 124i is to cause the temperature of the first processing server 124i to equal or exceed the threshold temperature 812 configured for the first processing server 124i. For example, when a sum of the value of the most recent temperature measurement 802a and the estimated heat generation value equals or exceeds the threshold temperature 812, AI model 160e predicts that the scheduled processing of the software application 140b by the first processing server 124i is to cause the temperature of the first processing server 124i to equal or exceed the threshold temperature 812.

In response to this prediction, AI model 160e identifies another processing server 124 that is assigned the same hardware tier 808 of tier-1 and is also available to process the software application 140b. For example, the AI model 160e determines that the second processing server 124j is assigned a hardware tier 808 of tier 1. Further, based on the software scheduling 804b associated with the second processing server 124j, the AI model 160e determines that the second processing server 124j is available to process the software application 140b. In response to this determination, the AI model 160e generates a recommendation 820 to migrate the processing of the software application 140b or one or more tasks 830 of the software application 140 from the first processing server 124i to the second processing server 124j. In response to obtaining the recommendation 820 as part of the results data 168, the controller 150 migrates processing of the software application 140b or one or more tasks 830 of the software application 140b from the first processing server 124i to the second processing server 124j.

In one embodiment, in response to determining that the second processing server 124j is assigned a hardware tier 808 of tier-1 and is available to processing the software application 140b, the AI model 160e first determines whether processing of the software application 140b at the second processing server 124j can cause the temperature of the second processing server 124j to equal or exceed a threshold temperature 812 configured for the second processing server 124j. The AI model 160e decides to migrate processing of the software application 140b or a portion thereof from the first processing server 124i to the second processing server 124j only when this processing is not expected to cause the temperature of the second processing server 124j to equal or exceed a respective threshold temperature 812. For example, based on the temperature measurements 802b (fed as part of input data 166) associated with the second processing server 124j, the AI model 160e may determine the most recent temperature measurement 802b at the second processing server 124j recorded by the respective heat sensor 132b. Based on the identification that the hardware tier 808 assigned to the second processing server 124i is tier-1 and based on the rate of heat 810 value associated with tier-1 processing servers 124, the AI model 160e may estimate heat to be generated by the second processing server 124j for processing the software application 140b. Then, based on the most recent temperature measurement 802b of the second processing server 124j and the estimated heat to be generated by the second processing server 124j, the AI model 160e predicts whether the processing of the software application 140b by the second processing server 124j is expected to cause the temperature of the second processing server 124j to equal or exceed the threshold temperature 812 configured for the second processing server 124j. For example, when a sum of the value of the most recent temperature measurement 802b and the estimated heat generation value is lower than the threshold temperature 812, AI model 160e predicts that the scheduled processing of the software application 140b by the second processing server 124j is not expected to cause the temperature of the second processing server 124j to equal or exceed the threshold temperature 812. In response, the AI model 160e generates a recommendation 820 to migrate the processing of the software application 140b or one or more tasks 830 of the software application 140 from the first processing server 124i to the second processing server 124j.

By keeping the temperature of the first processing server from exceeding its configured threshold temperature 812, the controller 150 avoids excessive heat from being generated by the first processing server, and thus lowers power consumption associated with cooling down an excessively hot processing server. Further, by avoiding the first processing server 124i from getting excessively hot, the controller 150 avoids the performance of the first processing server 124i from being compromised due to thermal throttling, component degradation, and thermal limits that are designed to protect the processor and maintain stable operation.

In one or more embodiments, HVAC solutions 130 (shown in FIG. 1) may include individual cooling equipment configured to manage heat for certain processing servers 124. For example, a first higher power cooling equipment may be employed to cool down the tier-1 first processing server 124i and a second relatively lower power cooling equipment may be employed to cool down the tier-2 third processing server 124k. In one embodiment, in the first and second use cases discussed above, once the processing of the software application 140b or a portion there of (particular task 830) is migrated from the first processing server 124i to the second processing server 124k, the controller 150 may shut down the first high power cooling equipment deployed for the first processing server 124i. Since the first higher power cooling equipment generally consumes higher power as compared to the second lower power cooling equipment, shutting down the first higher power cooling equipment saves power.

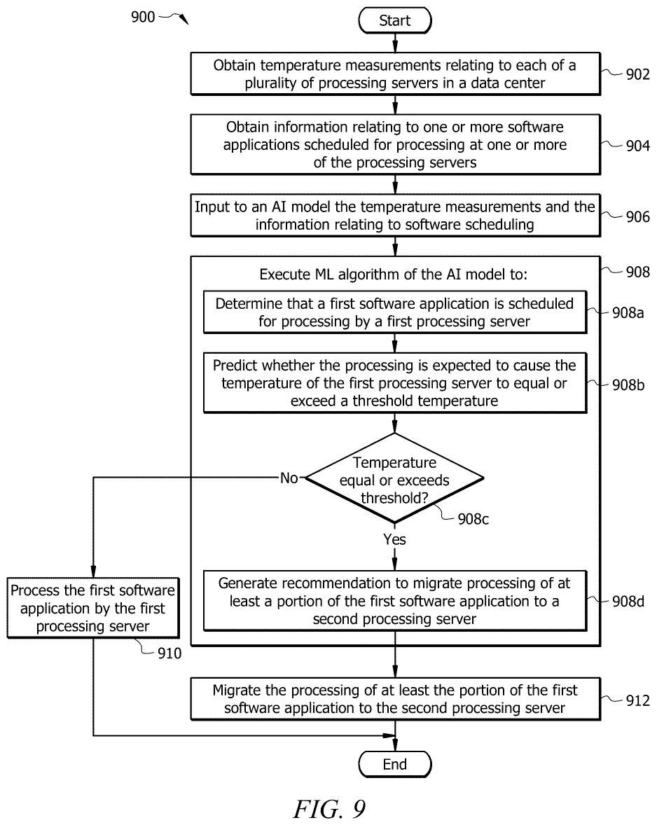

FIG. 9 illustrates a flowchart of an example method 900 for reducing power consumption in a data center 110, in accordance with one or more embodiments of the present disclosure. Method 900 may be performed by the controller 150 as shown in FIGS. 1 and 8. Method 900 is described herein with reference to FIG. 8.

At operation 902, the controller 150 obtains temperature measurements 802 relating to each of a plurality of processing servers 124 in a data center 110.

As described above, the hardware sensors 132 (shown in FIG. 1) deployed in the data center 110 include heat sensors 132 (shown as 132a, 132b, and 132c) that are configured to measure temperature at each of the processing servers 124 (e.g., first processing server 124i, second processing server 124g, third processing server 124k). As shown in FIG. 8, heat sensor 132a is configured to generate/record temperature measurements 802a including measured temperature readings of the first processing server 124i. Heat sensor 132b is configured to generate/record temperature measurements 802b including measured temperature readings of the second processing server 124j. Heat sensor 132c is configured to generate/record temperature measurements 802c including measured temperature readings of the third processing server 124k. In one embodiment, a heat sensor 132 may be configured to generate/record a temperature measurement 802 periodically or according to a pre-configured schedule. In one embodiment, controller 150 receives measurement signals from each of the heat sensors 132 (e.g., 132a, 132b, and 132c) and stores the corresponding temperature measurements 802 included or indicated by the measurement signals.

At operation 904, the controller 150 obtains information relating to one or more software applications 140 scheduled for processing at one or more of the processing servers 124.

As described above, the software scheduling 804 associated with a particular processing server 124 may include information relating to one or more software applications 140 scheduled for processing at the particular processing server 124. Additionally, the software scheduling 804 may include tasks scheduling 806 with information relating to one or more tasks 830 relating to each of the one or more software applications 140 scheduled for processing at the particular processing server 124. For example, as shown in FIG. 8, software scheduling 804a relating to the first processing server 124i includes an indication that the software application 140b is scheduled to process at the first processing server 124i. Software scheduling 804a additionally includes tasks scheduling 806 with information relating to one or more tasks 830 relating to the software application 140b that are scheduled for processing by the first processing server 124i. The software scheduling 894 may additionally include information relating to when each of the software applications 140 and each of the tasks 830 are scheduled to process at the respective processing servers 124. For example, software scheduling 804a includes information relating to when (e.g., time of day) the software application 140b and each task 830 is scheduled for processing at the first processing server 124i.

At operation 906, the controller 150 inputs to the AI model 160e the temperature measurements 802 and the information (e.g., software scheduling 804) relating to the software applications 140 scheduled for processing at the one or more processing servers 124. The AI model 160e may be trained based on one or more of a performance tier (e.g., hardware tiers 808) assigned to each of the processing servers 124 of the data center 110, wherein a higher performance tier assigned to a processing server 124 indicates a higher performance of the processing server 124 as compared to a lower performance tier; amount of heat generated per unit time of processing for a given performance tier (e.g., rate of heat 810); or performance tier (e.g., software tiers 814) needed to process each task 830 associated with each software application 140. In one embodiment, the AI model 160e is trained to optimize power consumption associated with cooling the processing servers 124 by determining migration of one or more software applications 140 or portions thereof (e.g., one or more tasks 830) among the processing servers 124 to distribute heat among the processing servers 124, based at least in part upon one or more of real time temperature measurements 802 of the processing servers 124, the software applications 140 scheduled for processing at one or more processing servers 124, the performance tier (e.g., hardware tier 808) assigned to each processing server 124, the amount of heat generated per unit time for a given performance tier (e.g., rate of heat 810), or performance tier (e.g., software tier 814) needed to process each task 830 associated with each software application 140 scheduled for processing at the one or more processing servers 124.

As described above, the AI model 160e is configured/trained to optimize power consumption in a data center 110 by generating recommendations 820 to migrate software applications 140 or portions thereof (e.g., one or more tasks 830) among the processing servers 124 deployed in the data center 110. For example, optimizing power consumption in the data center 110 may include reducing power consumption associated with cooling the processing servers 124 by recommending migration of one or more software applications 140 or portions thereof (e.g., one or more tasks 830) among the processing servers 124 to distribute heat among the processing servers 124. Additionally, or alternatively, optimizing power consumption in the data center 110 may include reducing power consumption by processing servers 124 by migrating one or more software applications 140 or portions thereof (e.g., one or more tasks 830) from a higher-performance (e.g., tier-1) processing server (e.g., first processing server 124i to a lower-performance (e.g., tier-2) processing server (e.g., third processing server 124k).

In one or more embodiments, the controller 150 may be configured to train the AI model 160e based on training data 164 to generate the recommendations 820 for migrating software applications 140/tasks 830 among processing servers 124. As shown in FIG. 8, the training data 164 used to train the AI model 160e includes one or more of hardware tiers 808 assigned to each processing server 124 (e.g., processing servers 124i, 124j, 124k), software tiers 814 assigned to each software application 140 scheduled for processing in the data center 110, a rate of heat 810 associated with each hardware tier 808, or a threshold temperature 812 associated with each processing server 124. The rate of heat 810 associated with a particular hardware tier 808 indicates an estimated amount of heat generated per unit time (e.g., per second, per minute etc.) of processing by a processing server 124 of the particular hardware tier 808. The estimated heat generated per unit time may include an average heat generated per unit time, a minimum heat generated per unit time, or a maximum heat generated per unit time. A threshold temperature 812 associated with a particular processing server 124 includes a maximum measured heat (e.g., measured in ° C./° F.) that is not to be exceeded for the processing server 124.

Once the AI model 160e is trained, the controller 150 may be configured to execute the ML algorithm 162e to generate a recommendation 820 based on input data 166 fed to the AI model 160e. As shown in FIG. 8, the input data 166 fed to the AI model 160e includes temperature measurements 802 relating to each of a plurality of processing servers 124 (e.g., first processing server 124i, second processing server 124g, third processing server 124k), software scheduling 804 relating to software application(s) scheduled for processing at each of the plurality of processing servers 124, or a combination thereof.

At operation 908, the controller 150 executes a machine-learning algorithm 162e associated with the AI model 160e to perform a plurality of operations including operations 908A, 908B, 908C, and 908D.

As described above, once input data 166 is fed to the AI model 160e, execution of the ML algorithm 162e causes the AI model 160e to generate a recommendation 820 for migrating at least a portion of a software application 140 or one or more tasks 830 associated with a software application 140 that are scheduled for processing at one processing server 124 to another processing server 124 to save power.

At operation 908A, the AI model 160e determines, based on the information relating to the one or more software applications scheduled for processing at one or more of the processing servers 124, that the first software application (e.g., software application 140b) is scheduled for processing by the first processing server 124i.

As described above, based on the information relating to the software scheduling 804a (fed as part of input data 166) associated with the first processing server 124i, the AI model 160e determines that the software application 140b is scheduled for processing by the first processing server 124i.

At operation 908B, the AI model predicts whether the scheduled processing of the first software application (e.g., software application 140b) by the first processing server 124i is expected to cause the temperature of the first processing server 124i to equal or exceed a threshold temperature 812.

As described above, after determining that the software application 140b is scheduled for processing by the first processing server 124i, the AI model 160e predicts whether the scheduled processing of the software application 140b by the first processing server 124i is to cause the temperature of the first processing server 124i to equal or exceed the threshold temperature 812 configured for the first processing server 124i. For example, based on the temperature measurements 802a (fed as part of input data 166) associated with the first processing server 124i, the AI model 160e may determine the most recent temperature measurement 802a at the first processing server 124i recorded by the heat sensor 132a. Further, the AI model 160e may identify that the hardware tier 808 assigned to the first processing server 124i is tier-1, and based on the rate of heat 810 value associated with tier-1 processing servers 124, the AI model 160e may estimate heat to be generated by the first processing server 124i for processing the software application 140b. Then, based on the most recent temperature measurement 802a of the first processing server 124i and the estimated heat to be generated by the first processing server 124i, the AI model 160e predicts whether the scheduled processing of the software application 140b by the first processing server 124i is to cause the temperature of the first processing server 124i to equal or exceed the threshold temperature 812 configured for the first processing server 124i.

At operation 908C, if the AI model 160e predicts that the scheduled processing of the first software application (e.g., software application 140b) by the first processing server 124i is not expected to cause the temperature of the first processing server 124i to equal or exceed the threshold temperature 812, method 900 proceeds to operation 910 where the controller 150 allows the first processing server 124i to process the first software application (e.g., software application 140b).

On the other hand, if the AI model 160e predicts that the scheduled processing of the first software application (e.g., software application 140b) by the first processing server 124i is expected to cause the temperature of the first processing server 124i to equal or exceed the threshold temperature 812, the method 900 proceeds to operation 908D where the AI model 160e generates a recommendation 820 to migrate the processing of at least a portion (e.g., one or more tasks 830) of the first software application (e.g., software application 140b) from the first processing server 124i to a second processing server 124j.

As described above, when a sum of the value of the most recent temperature measurement 802a and the estimated heat generation value equals or exceeds the threshold temperature 812, AI model 160e predicts that the scheduled processing of the software application 140b by the first processing server 124i is to cause the temperature of the first processing server 124i to equal or exceed the threshold temperature 812. In response to this prediction, AI model 160e identifies another processing server 124 that is assigned the same hardware tier 808 of tier-1 and is also available to process the software application 140b. For example, the AI model 160e determines that the second processing server 124j is assigned a hardware tier 808 of tier 1. Further, based on the software scheduling 804b associated with the second processing server 124j, the AI model 160e determines that the second processing server 124j is available to process the software application 140b. In response to this determination, the AI model 160e generates a recommendation 820 to migrate the processing of the software application 140b or one or more tasks 830 of the software application 140 from the first processing server 124i to the second processing server 124j.

At operation 912, based on the recommendation 820, the controller 150 migrates the processing of the first software application (software application 140b) or the portion thereof (e.g., one or more tasks 830) from the first processing server 124i to the second processing server 124j.

As described above. in response to obtaining the recommendation 820 as part of the results data 168, the controller 150 migrates processing of the software application 140b or one or more tasks 830 of the software application 140b from the first processing server 124i to the second processing server 124j.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a memory storing an Artificial Intelligence (AI) model; and
a processor communicatively coupled to the memory and configured to:
obtain temperature measurements relating to each of a plurality of processing servers in a data center;
obtain information relating to one or more software applications scheduled for processing at one or more of the processing servers;
input to the AI model the temperature measurements and the information relating to the software applications scheduled for processing at the one or more processing servers, wherein:
the AI model is trained based on at least one or more of:
a performance tier assigned to each of the processing servers of the data center, wherein a higher performance tier assigned to a processing server indicates a higher performance of the processing server as compared to a lower performance tier;
amount of heat generated per unit time of processing for a given performance tier; or
performance tier needed to process each task associated with each software application; and
the AI model is trained to optimize power consumption associated with cooling the processing servers by determining migration of one or more software applications or portions thereof among the processing servers to distribute heat among the processing servers, based at least in part upon one or more of real time temperature measurements of the processing servers, the software applications scheduled for processing at one or more processing servers, the performance tier assigned to each processing server, the amount of heat generated per unit time for a given performance tier, or performance tier needed to process each task associated with each software application scheduled for processing at the one or more processing servers;
execute a machine-learning algorithm associated with the AI model to:
generate a recommendation to migrate at least a portion of processing of a first software application scheduled to process at a first processing server to a second processing server; and
migrate, based on the recommendation, the portion of the processing of the first software application from the first processing server to the second processing server.

2. The system of claim 1, wherein the processor is further configured to execute the machine-learning algorithm associated with the AI model to:
determine, based on the information relating to the one or more software applications scheduled for processing at one or more of the processing servers, that the first software application is scheduled for processing by the first processing server;
predict that the scheduled processing of the first software application by the first processing server can cause the temperature of the first processing server to equal or exceed a threshold temperature;
in response to the prediction, determine to migrate the processing of the first software application from the first processing server to the second processing server; and
generate the recommendation to migrate the processing of the first software application from the first processing server to the second processing server.

3. The system of claim 2, wherein the processor is further configured to execute the machine-learning algorithm associated with the AI model to:
determine, from the temperature measurements relating to each of the plurality of processing servers, a first temperature measurement of the first processing server;
determine, based at least in part on a first performance tier associated with the first processing server and the heat generated per unit time of processing for the first performance tier, an estimated heat to be generated for processing the first software application by the first processing server; and
predict, based on the first temperature measurement of the first processing server and the estimated heat to be generated for processing the first software application, that the scheduled processing of the first software application by the first processing server can cause the temperature of the first processing server to equal or exceed the threshold temperature.

4. The system of claim 2, wherein the processor is further configured to execute the machine-learning algorithm associated with the AI model to:
determine, based on the temperature measurements relating to each of the plurality of processing servers, a second temperature measurement of the second processing server;
determine that the second processing server is also associated with the first performance tier;
determine, based at least in part on the heat generated per unit time of processing for the first performance tier, an estimated heat to be generated for processing the first software application by the second processing server; and
predict, based on the second temperature measurement of the second processing server and the estimated heat to be generated for processing the first software application by the second processing server, that the processing of the first software application by the second processing server cannot cause the temperature of the second processing server to equal or exceed the threshold temperature;
in response to the prediction, determine to migrate the processing of the first software application from the first processing server to the second processing server.

5. The system of claim 1, wherein the processor is further configured to execute the machine-learning algorithm associated with the AI model to:
determine that one or more tasks associated with the first software application are associated with a first processing tier that is lower than a second processing tier associated with the first processing server;
in response to determining that the one or more tasks are associated with the first processing tier, determine the second processing server associated with the first processing tier; and
determine to migrate the one or more tasks associated with the first software application for processing by the second processing server.

6. The system of claim 5, wherein the processor is further configured to execute the machine-learning algorithm associated with the AI model to:
determine to migrate back the processing of the first software application to the first processing server after the one or more tasks have been processed by the second processing server.

7. The system of claim 5, wherein a first cooling equipment configured to cool down the first processing server consumes higher electrical power as compared to a second cooling equipment configured to cool down the second processing server.

8. The system of claim 1, wherein the processor is further configured to:
shut down cooling equipment configured to cool down the first processing server, after the migration of the first software application to the second processing server is complete.

9. A method comprising:
obtaining temperature measurements relating to each of a plurality of processing servers in a data center;
obtaining information relating to one or more software applications scheduled for processing at one or more of the processing servers;
inputting to an Artificial Intelligence (AI) model the temperature measurements and the information relating to the software applications scheduled for processing at the one or more processing servers, wherein:
the AI model is trained based on at least one or more of:
a performance tier assigned to each of the processing servers of the data center, wherein a higher performance tier assigned to a processing server indicates a higher performance of the processing server as compared to a lower performance tier;
amount of heat generated per unit time of processing for a given performance tier; or
performance tier needed to process each task associated with each software application; and
the AI model is trained to optimize power consumption associated with cooling the processing servers by determining migration of one or more software applications or portions thereof among the processing servers to distribute heat among the processing servers, based at least in part upon one or more of real time temperature measurements of the processing servers, the software applications scheduled for processing at one or more processing servers, the performance tier assigned to each processing server, the amount of heat generated per unit time for a given performance tier, or performance tier needed to process each task associated with each software application scheduled for processing at the one or more processing servers;
executing a machine-learning algorithm associated with the AI model to:
generate a recommendation to migrate at least a portion of processing of a first software application scheduled to process at a first processing server to a second processing server; and
migrating, based on the recommendation, the portion of the processing of the first software application from the first processing server to the second processing server.

10. The method of claim 9, further comprising executing the machine-learning algorithm associated with the AI model to:
determine, based on the information relating to the one or more software applications scheduled for processing at one or more of the processing servers, that the first software application is scheduled for processing by the first processing server;
predict that the scheduled processing of the first software application by the first processing server can cause the temperature of the first processing server to equal or exceed a threshold temperature;
in response to the prediction, determine to migrate the processing of the first software application from the first processing server to the second processing server; and
generate the recommendation to migrate the processing of the first software application from the first processing server to the second processing server.

11. The method of claim 10, further comprising executing the machine-learning algorithm associated with the AI model to:
determine, from the temperature measurements relating to each of the plurality of processing servers, a first temperature measurement of the first processing server;
determine, based at least in part on a first performance tier associated with the first processing server and the heat generated per unit time of processing for the first performance tier, an estimated heat to be generated for processing the first software application by the first processing server; and
predict, based on the first temperature measurement of the first processing server and the estimated heat to be generated for processing the first software application, that the scheduled processing of the first software application by the first processing server can cause the temperature of the first processing server to equal or exceed the threshold temperature.

12. The method of claim 10, further comprising executing the machine-learning algorithm associated with the AI model to:
determine, based on the temperature measurements relating to each of the plurality of processing servers, a second temperature measurement of the second processing server;
determine that the second processing server is also associated with the first performance tier;
determine, based at least in part on the heat generated per unit time of processing for the first performance tier, an estimated heat to be generated for processing the first software application by the second processing server; and
predict, based on the second temperature measurement of the second processing server and the estimated heat to be generated for processing the first software application by the second processing server, that the processing of the first software application by the second processing server cannot cause the temperature of the second processing server to equal or exceed the threshold temperature;
in response to the prediction, determine to migrate the processing of the first software application from the first processing server to the second processing server.

13. The method of claim 9, further comprising executing the machine-learning algorithm associated with the AI model to:
determine that one or more tasks associated with the first software application are associated with a first processing tier that is lower than a second processing tier associated with the first processing server;
in response to determining that the one or more tasks are associated with the first processing tier, determine the second processing server associated with the first processing tier; and
determine to migrate the one or more tasks associated with the first software application for processing by the second processing server.

14. The method of claim 13, further comprising executing the machine-learning algorithm associated with the AI model to:
determine to migrate back the processing of the first software application to the first processing server after the one or more tasks have been processed by the second processing server.

15. The method of claim 13, wherein a first cooling equipment configured to cool down the first processing server consumes higher electrical power as compared to a second cooling equipment configured to cool down the second processing server.

16. The method of claim 9, further comprising:
shutting down cooling equipment configured to cool down the first processing server, after the migration of the first software application to the second processing server is complete.

17. A non-transitory computer-readable medium storing instructions that when executed by a processor causes the processor to:
obtain temperature measurements relating to each of a plurality of processing servers in a data center;
obtain information relating to one or more software applications scheduled for processing at one or more of the processing servers;
input to an Artificial Intelligence (AI) model the temperature measurements and the information relating to the software applications scheduled for processing at the one or more processing servers, wherein:
the AI model is trained based on at least one or more of:
a performance tier assigned to each of the processing servers of the data center, wherein a higher performance tier assigned to a processing server indicates a higher performance of the processing server as compared to a lower performance tier;
amount of heat generated per unit time of processing for a given performance tier; or
performance tier needed to process each task associated with each software application; and
the AI model is trained to optimize power consumption associated with cooling the processing servers by determining migration of one or more software applications or portions thereof among the processing servers to distribute heat among the processing servers, based at least in part upon one or more of real time temperature measurements of the processing servers, the software applications scheduled for processing at one or more processing servers, the performance tier assigned to each processing server, the amount of heat generated per unit time for a given performance tier, or performance tier needed to process each task associated with each software application scheduled for processing at the one or more processing servers;
execute a machine-learning algorithm associated with the AI model to:
generate a recommendation to migrate at least a portion of processing of a first software application scheduled to process at a first processing server to a second processing server; and
migrate, based on the recommendation, the portion of the processing of the first software application from the first processing server to the second processing server.

18. The non-transitory computer-readable medium of claim 17, wherein the instructions further cause the processor to execute the machine-learning algorithm associated with the AI model to:
determine, based on the information relating to the one or more software applications scheduled for processing at one or more of the processing servers, that the first software application is scheduled for processing by the first processing server;
predict that the scheduled processing of the first software application by the first processing server can cause the temperature of the first processing server to equal or exceed a threshold temperature;
in response to the prediction, determine to migrate the processing of the first software application from the first processing server to the second processing server; and
generate the recommendation to migrate the processing of the first software application from the first processing server to the second processing server.

19. The non-transitory computer-readable medium of claim 18, wherein the instructions further cause the processor to execute the machine-learning algorithm associated with the AI model to:
determine, from the temperature measurements relating to each of the plurality of processing servers, a first temperature measurement of the first processing server;
determine, based at least in part on a first performance tier associated with the first processing server and the heat generated per unit time of processing for the first performance tier, an estimated heat to be generated for processing the first software application by the first processing server; and
predict, based on the first temperature measurement of the first processing server and the estimated heat to be generated for processing the first software application, that the scheduled processing of the first software application by the first processing server can cause the temperature of the first processing server to equal or exceed the threshold temperature.

20. The non-transitory computer-readable medium of claim 18, wherein the instructions further cause the processor to execute the machine-learning algorithm associated with the AI model to:
determine, based on the temperature measurements relating to each of the plurality of processing servers, a second temperature measurement of the second processing server;
determine that the second processing server is also associated with the first performance tier;
determine, based at least in part on the heat generated per unit time of processing for the first performance tier, an estimated heat to be generated for processing the first software application by the second processing server; and
predict, based on the second temperature measurement of the second processing server and the estimated heat to be generated for processing the first software application by the second processing server, that the processing of the first software application by the second processing server cannot cause the temperature of the second processing server to equal or exceed the threshold temperature;
in response to the prediction, determine to migrate the processing of the first software application from the first processing server to the second processing server.
